(19) United States
(12) Patent Application Publication
(10) Pub. No.: US 2025/0282981 A1
(43) Pub. Date: Sep. 11, 2025

(54) METHODS OF MAKING POLYMER FILMS

(71) Applicant: Lubris LLC, Naples, FL (US)

(72) Inventors: George Warren Greene, IV, Eltham, Victoria (AU); Pauline Emilienne Desroches, Richmond, Victoria (AU); Saimon Moraes Silva, Sandringham, Victoria (AU); Simon Edward Moulton, Tullimbar, Victoria (AU); Anita Frances Quigley, West Melbourne, Victoria (AU); Robert Michail Ivan Kapsa, West Melbourne, Victoria (AU)

(73) Assignees: Lubris LLC, Naples, FL (US); Deakin University, Geelong, Victoria (AU); Swinburne University of Technology, Hawthorn, Victoria (AU); The University of Wollongong, Wollongong, New South Wales (AU)

(21) Appl. No.: 18/860,226

(22) PCT Filed: Apr. 26, 2023
(86) PCT No.: PCT/US2023/066242

§ 371 Date: Oct. 25, 2024

Related U.S. Application Data
(60) Provisional application No. 63/335,473, filed on Apr. 27, 2022.

(51) Int. Cl. C09J 7/22; C09J 7/38; C09J 9/02

(52) U.S. Cl. CPC C09J 7/22; C09J 7/38; C09J 9/02; C09J 2301/202

(57) ABSTRACT

Disclosed herein, in part, are nanometers-thin and uniformly thick polymer films comprising an electrochemically polymerized polymer and a polyelectrolyte. Methods of preparing said nanometers-thin and uniformly thick polymer films are also provided.

### CROSS-REFERENCE TO RELATED APPLICATIONS

This application claims priority to and the benefit of U.S. Provisional Patent Application No. 63/335,473 filed Apr. 27, 2022, the contents of which are incorporated by reference herein in its entirety.

### BACKGROUND

Organic films have received significant interest in the development of electronics, optoelectronics, and sensors. Such films have numerous beneficial properties, including, but not limited to, good ionic and electronic conductivity, facile synthesis, responsiveness to electrical stimuli, and smooth morphology. Specifically, nanometer-thin conductive polymer (CP) films are needed in applications such as electrode coatings for bionic implants, biosensors, water monitoring, organic electronic circuits, nano actuators, and flexible and wearable electronics, where nanoscale film thickness is required due to the size of the devices getting smaller and where non-uniformity is a significant issue.

At present, the most practical process for synthesizing conductive polymer thin films is via electrochemical polymerization. (Guimard et al., Progress in Polymer Science, 2007, 32 (8-9), 876-921) Advantages of using an electrochemical polymerization process include: simple setup with a monomer and a dopant in solution, more accurate control of the reaction condition, a more extensive range of dopant molecule, and possible thin film synthesis. While electrochemical polymerization of CP films is simple and straightforward, it does not allow the desired level of control over the film topography and usually results in a thick and non-uniform film with high surface roughness and density gradients over the film surface. Typically, electrosynthesis parameters including electrodeposition time, temperature, electrolyte concentration (monomer and dopant), and applied current, have to be considered during the synthesis, as these parameters control the resulting film topography. Substrate topography is also an important parameter, with a charge gradient due to the surface roughness often leading to a non-uniform growth.

Consequently, it is nearly impossible to grow a uniformly thick and relatively smooth conductive polymer film using traditional doping methods. The film topography is not easily controllable via reaction kinetics, as it depends on variables, such as dopant and monomer diffusion, surface charge density, distribution across the surface, and electron transfer rates. All these variables have to be finely optimized in order to synthesize reproducible films, which is highly challenging to prepare at the macro-scale and almost impossible to prepare at the nano-scale.

Other techniques for preparing CP thin films have been investigated, including processes from a polymer solution, such as spreading, dipping or spin-casting methods. (Xu et al., Carbon, 2010, 48 (11), 3308-3311) These techniques are quick and straightforward to apply, but the resulting films have poor uniformity, and the film thickness reaches 100s of nm, and often larger. Thin polymer films can also be prepared from a monomer in solution, with techniques including plasma polymerization (Shi, Surface and Coatings Technology, 1996, 82 (1-2), 1-15), layer-by-layer deposition (Cheung et al., Molecular self-assembly of conducting polymers, 5; Yuan et al., Langmuir, 2002, 18 (8), 3343-3351) and admicellar polymerization. (Castano et al., Macromolecular Bioscience, 2004, 4 (8), 785-794; Yuan et al, 2002) However in most cases these techniques require long and challenging processes, which again can only be applied effectively to surfaces with simple geometries.

Therefore, there is an unmet need to develop new methods for preparing a polymer film such as a CP film with desired properties, for example, nanometers-thin with uniform thickness as well as low surface roughness.

### SUMMARY

In one aspect, the present disclosure provides polymer films, which can be nanometers-thin and uniformly thick as well as having improved surface roughness. Using the methods described herein, the polymer films are electrochemically grown using self-assembled polyelectrolytes that can form a brush-like structure on a substrate, which polyelectrolyte functions as both a dopant (e.g., multiple ionic charges) and a template (e.g., thickness and density of brush-like structure) that controls the morphology of the resulting polymer film. This surface grafted dopant templating approach decouples the film morphology from the kinetics of the reaction and determines the polymer film thickness, surface roughness and nanoporosity by the self-assembled polyelectrolyte. Using this approach, polymer films such as CP films are realized that are ultra-thin (e.g., less than about 15 nm or 10 nm), effectively invisible to light (e.g., optically transparent), continuous, and nanoporous. The nanoporosity of the polymer film lends itself to the creation of composite polymer films where a second polymer is polymerized within the pores of the first polymer thereby creating a composite system including two distinct, continuous and interpenetrating polymers. The polymer films of the present disclosure can be reproducibly made for a variety of uses including optoelectronics, biosensors, controlled drug delivery, bionic implantable electrodes, flexible electronics, filtration apparatus, and microcircuitry (e.g., patterned polyelectrolyte layers that subsequently are used to polymerize appropriate monomers into conductive polymers as the circuitry).

In various embodiments, the polymer film comprises an electrochemically polymerized polymer. In some embodiments, the polymer film comprises an electrochemically polymerized polymer; and a polyelectrolyte. In certain embodiments, the polymer film further includes a second electrochemically polymerized polymer, where the first electrochemically polymerizable polymer and the second electrochemically polymerizable polymer can be interpenetrating and continuous. Such structures are referred to herein as a “composite polymer films.”

Such polymer films can have a thickness of less than or equal to about 200 nm or about 150 nm or about 100 nm and/or a root mean square (RMS) surface roughness of less than or equal to about 10 nm or about 5 nm. The thickness and roughness and other properties of the resulting polymer film can be controlled by design of the polyelectrolyte and the properties of the brush-like monolayer of polyelectrolyte coated on the surface of a substrate such as the height of the polyelectrolyte's “bristles,” their density, and their charge capacity, as well as the monomers and number and length of CV cycles applied to polymerize them, among factors.

In various embodiments, the polyelectrolyte comprises a bristle component and an adhesive component, where the adhesive component can be associated with a substrate. For example, the adhesive component can be associated or interact with the substrate via a covalent bond, an ionic bond, a hydrogen bond, a van der Waals interaction, a metallic bond, or a combination thereof. In some embodiments, the substrate is a conductive surface. In certain embodiments, the substrate is an electrode. In particular embodiments, the polymer film can be removed from the substrate.

In some embodiments, the polymer film is nanoporous, for example, having a total porosity from 20% to about 80%. In certain embodiments, the polymer film is a CP film and can have a conductivity from about 0.1 Siemens per centimeter (S/cm) to about 100 S/cm. In particular embodiments, the polymer film has an optical transmission in the visible light wavelengths from about 60% to about 97%.

In various embodiments, the polymer film further comprises a cationic compound, an anionic compound, a neutral compound, or a combination thereof, where one or more of these compounds can be a therapeutic agent.

Another aspect of the disclosure provides methods of preparing a polymer film as described herein. In various embodiments of the disclosure, a method of preparing a polymer film generally includes:
(a) contacting a solution comprising a plurality of one or more electropolymerizable monomers with a monolayer of a polyelectrolyte coated on a substrate; and
(b) applying one or more cycling voltammetry (CV) cycles to the solution to form the polymer film.
   The resulting polymer film can have a thickness of less than or equal to about 200 nm or about 150 nm or about 100 nm and/or a RMS surface roughness of less than or equal to about 10 nm or about 5 nm.

As mentioned above, the polyelectrolyte can include a bristle component and an adhesive component, where the adhesive component can associate with a substrate. In some embodiments, the polyelectrolytes self-assemble on a substrate with their adhesive components associated with the substrate and their bristle components oriented substantially away from (e.g., substantially normal or perpendicular to) the substrate to form a brush-like structure on the substrate. The brush-like monolayer of polyelectrolytes can have the substantially same height or thickness across the substrate, thereby influencing the uniformity of the resulting electrochemically polymerized polymer film formed using the ionic charges of the polyelectrolytes.

In some embodiments, the bristle component may comprise one or more ionic chemical functional groups such as a hydroxyl group, a carbohydrate moiety, a zwitterionic group, and combinations thereof. In certain embodiments, the bristle component comprises from about 50 to about 200 ionic charges, for example, anionic charges, per polyelectrolyte molecule. In particular embodiments, the polyelectrolyte includes a lubricin.

In use, the polyelectrolyte acts as a dopant such that when in the presence of electrochemically polymerizable monomers and an electric potential is applied, nucleation occurs at the location of the ionic charges along the polyelectrolytes facilitating electrochemically catalyzed polymerization of the monomers along the polyelectrolyte bristles. When another electric potential is applied, the polymer continues to grow along and between the bristles, beginning to compress the monolayer and forming a substantially uniform thickness across the substrate. With repeated application of electric potentials, the polymer film is formed having the properties as described herein.

Another aspect of the disclosure provides a multilayered polymer film, including two or more layers of a polymer film as described herein, and methods of preparing a multilayered polymer film.

### BRIEF DESCRIPTION OF THE DRAWINGS

FIGS. 1A-1D are depictions of exemplary polyelectrolytes of the present disclosure, where FIG. 1D depicts a monolayer of polyelectrolytes coated on a substrate.

FIGS. 2A-2F: (A) Change in frequency, ΔF, and dissipation, ΔD, of a typical quartz crystal microbalance (QCM) experiment where phosphate buffered saline (PBS) was introduced into the QCM electrochemical cell, followed by the QCM crystal sensor being coated with lubricin (LUB) (100 mg mL⁻¹ in PBS solution, incubated for 10 minutes and then rinsed with PBS until a baseline was reached). The electropolymerization of Py (0.2 M) on the LUB coated Au QCM crystal was performed for 24 cycles at a scan rate of 5 mV s⁻¹ with a potential scan from −0.1 V to +1.1 V (vs. Ag|AgCl). (B) Graph showing the ΔF drop against the number of CV cycles. (C) Electropolymerization of pyrrole (Py) (0.2 M) on a LUB-coated Au electrode (LUB 100 mg mL⁻¹ in PBS solution, incubated for 30 minutes and then quickly washed with Milli-Q water) at a scan rate of 5 mV s⁻¹ with a potential scan from −0.1 V to +1.1 V (vs. Ag|AgCl) (D) Cyclic voltammograms measured in a PBS solution using a scan rate of 100 mV s⁻¹, with a potential window of −0.8V to +0.8V (vs. Ag|AgCl) of a bare Au electrode and a polypyrrole (PPy) grown for 5 CV cycles (E) Impedance spectra for the bare Au electrodes and Au/PPy 5 CV at +0.2 V (vs. Ag|AgCl) measured in PBS (pH 7.4). (F) Nyquist plot measured at a bare Au electrodes and Au/PPy 5 CV. Experiments were measured in K₃[Fe(CN)₆] solution (3.6 mM) prepared in PBS (pH 7.4) at +0.3 V (vs. Ag|AgCl).

FIGS. 3A-3E: Cyclic voltammograms measured in a PBS solution using a scan rate of 100 mV s⁻¹, with a potential window of −0.8 V to +0.8 V (vs. Ag|AgCl) for 10 CV of (A) a bare Au electrode, (B) a LUB-coated Au electrode, a LUB-coated Au electrode, electropolymerised with Py for (C) 2, (D) 5 and (E) 10 CV cycles. The scan rate of the electropolymerisation for all surfaces is 5 mV s⁻¹.

FIG. 4 is a schematic representation of the circuit used to calculate the R_{ct} values presented herein.

FIGS. 5A-5C and 5A′-5C′ are cyclic voltammograms of Py (0.2 M) electropolymerization using tethered LUB (100 μg·mL⁻¹ in PBS) as a dopant for 2 cycles using a scan rate of (A) 5 mV s⁻¹; (B) 10 mV s⁻¹ and (C) 50 mV s⁻¹ and cyclic voltammograms of the films measured in a PBS solution using a scan rate of 100 mV s⁻¹, with a potential window of −0.8 V to +0.8 V (FIGS. A′, B′, and C′, respectively).

FIGS. 6(a)-(a″), (b)-(b″), (c)-(c″), (d)-(d″) and (e)-(e″) are XPS spectrum of (a's) a LUB-coated Au electrode, a PPy coated Au electrode for (b's) 2, (c's) 5, (d's) 10 CV at 5 mV s⁻¹ with of Py (0.2 M), and (e's) a LUB-coated Au electrode polymerized without dopant in solution for 2 CV with Py (0.2 M). All the electropolymerizations were conducted from −0.1 V to +1.1 V (vs. Ag|AgCl).

FIGS. 7A-7E: (A₁-A₅) Tapping mode atomic force microscopy (AFM) images showing the step height of PPy at 5 (A₁), 10 (A₂), 20 (A₃), 30 (A₄) and 40 (A₅) CV cycles. Images are 5×5 μm, scale bar 1 μm. (B₁-B₅) Thickness profile (nm) of cross-section (corresponding to the white lines on AFM images) of PPy at 5 (B₁), 10 (B₂), 20 (B₃), 30 (B₄) and 40 (B₅) CV cycles. (C) Film thickness and roughness against the number of CV cycles. (D) Scanning Electron Microscopy (SEM) image of focused ion beam (FIB) cross-section of a PPy electropolymerized Au electrodes for 2 CV cycles in Py (0.2 M) on a chrome and Au sputter-coated glass slide, tilted at 30°. Scale bar 200 nm. (E) Transmission Electron Microscopy (TEM) image of PPy electropolymerized for 2 CV cycles in Py (0.2 M) on a TEM grid. Scale bar 200 nm. It is noted that the AFM image and step height for the 10 CV cycles film (A₂ and B₂, respectively) presents 2 steps in the film with the smaller step caused by monomer solution leaking under the masking tape used during the surface preparation, leading to unwanted polymerization in this region. This extra step is not considered during the image analysis in (C). Likewise, the indium tin oxide (ITO) substrate used in the preparation of the 30 CV cycle film (i.e., A₄ and B₄) showed a much greater roughness than those used in the other film preparations and so likewise led to an artificially higher film ‘rougher’ in the analysis in (C).

FIGS. 8A-8C is a nanometers-thin PPy film growth schematic, where immobilized LUB acts as a dopant (polyelectrolyte). LUB, a self-assembled glycoprotein, negatively charged, is about 100 nm in height and is adhered to the Au surface to form a LUB monolayer that coats the substrate and has a looped rug or bottle brush-like appearance (FIG. 8A). In the presence of Py monomers in solution and when a potential is applied, polymerization of Py occurs where negative charges are created on and along the LUB “bristles,” resulting in PPy coating the LUB molecules, compressing the LUB layer, and creating a nanoporous structure (FIG. 8B). After additional CV cycles, the polymer continues to grow within the nanopores, thereby controlling the morphology of the resulting polymer film (FIG. 8C).

FIGS. 9A and 9B show the change in frequency, ΔF, and dissipation, ΔD, of a typical QCM experiment where the QCM crystal sensor was run in PBS, then coated with LUB (100 μg mL⁻¹ in PBS solution, incubated for 10 minutes and then rinsed with PBS until a baseline was reached). The electropolymerization of Py (0.2 M) was done for (A) 1 CV cycle and (B) 2 cycles at a scan rate of 5 mV s⁻¹ with a potential scan from −0.1 V to +1.1 V (vs. Ag|AgCl). BSA (300 μL at 2 mg mL⁻¹) was flowed through the QCM cell and then washed with PBS at the same flow rate.

FIGS. 10A-10C: (A) Change in frequency, ΔF, and dissipation, ΔD, of a typical QCM experiment where the QCM crystal sensor was run in PBS, then coated with LUB (100 mg mL⁻¹ in PBS solution, incubated for 10 minutes and then rinsed with PBS until a baseline was reached). Py (0.2 M) was introduced in the cell, and the electropolymerization was done for 2 cycles at a scan rate of 5 mV s⁻¹ with a potential scan from −0.1 V to +1.1 V (vs. Ag|AgCl), followed by a PBS wash. 3,4-Ethylene dioxythiophene (EDOT) was introduced in the cell and the electropolymerization of EDOT (0.01 M) was done for 2 CV at a scan rate of 5 mV s⁻¹ with a potential scan from −0.6 V to +1.1 V (vs. Ag|AgCl) followed by a PBS wash. (B) Cyclic voltammograms measured in a PBS solution using a scan rate of 100 mV s⁻¹, with a potential window of −0.8 V to +0.8 V (vs. Ag|AgCl) of a bare Au electrode, a LUB-coated Au electrode for 30 minutes, an Au electrode electropolymerized with EDOT (0.01 M) for 5 CV at a scan rate of 5 mV s⁻¹ (C) PPy/poly(3,4-ethylene dioxythiophene (PEDOT) composite structure—an incomplete polymerization of PPy results in a porous film (1), with the addition of a second monomer, which polymerizes within the pores of the previously deposited polymer (2).

FIG. 11 shows cyclic voltammograms measured in a PBS solution using a scan rate of 100 mV s⁻¹, with a potential window of −0.8 V to +0.8 V (vs. Ag|AgCl) of a bare Au electrode, a LUB-coated Au electrode for 30 minutes, an Au electrode electropolymerized with EDOT (0.01 M) for 5 CV at a scan rate of 5 mV s⁻¹.

FIGS. 12(a)-(a″), (b)-(b″), and (c)-(c″) are XPS spectrum of (a) a LUB-coated Au electrode, (b) a PEDOT coated Au electrode for 2 CV at 5 mV s⁻¹ with EDOT (0.01 M), (c) a PEDOT coated Au electrode for 5 cycles at 5 mV s⁻¹ with EDOT (0.01 M). All the electropolymerization are done from −0.6 V to +1.1 V (vs. Ag|AgCl).

### DETAILED DESCRIPTION

It has now been discovered that certain electrolytes, for example, certain polyelectrolytes, acting as a dopant, can self-assemble on a surface in any pattern desired, and can act as a three-dimensional template which can modulate formation of a polymer film so as to control its shape, thickness, porosity, and uniformity on a nanometer scale. Application of such a polyelectrolyte to a substrate results in self-assembly of its molecules into a brush-like monolayer, with one or more regions of each polyelectrolyte molecule associated, typically by adsorption, with the surface of the substrate, and a charged, elongate region (the “bristle” of the brush-like monolayer) directed generally or substantially normal or perpendicular to the substrate surface. The currently preferred electrolytes are various species and variants of the glycoprotein known as Lubricin, or PRG4, described in detail herein.

Subsequent application to and reaction of monomers within the dopant layer results in a polymeric film encapsulating the electrolyte's brush-like structure, leading first to a porous film with a network structure that reflects that of the brush-like layer, and a thickness modulated by the length of the bristle. Subsequent rounds of polymerization results in a polymer film structure similar to that observed with traditionally polymerized films, but with far more uniform thickness and surface smoothness. With continued electrochemical polymerization, polymer growth can occur primarily within the pores of the already formed tortuous porous network. The pores thus are filled in, leading to a denser polymer film when the electrolyte is totally covered (i.e., when no charges are available and the polymerization is completed). Interestingly, with continued electrochemical polymerization, the thickness of the resulting polymer film, although denser and more solid, does not become substantially thicker.

Thus, the growth of the polymer film can be controlled, which is templated by the brush-like polyelectrolyte's molecular structure and function, resulting in a polymer film that can be ultra-smooth, uniformly thick, and conform to the nano-, micro-, and macro-scale structures of the substrate. The templating morphology of the dopant monolayer controls the film structure thereby disconnecting the “reaction kinetics” (e.g., diffusion, charge density and distribution, etc.), which are nearly impossible to control effectively using other solution or deposition techniques to obtain thin uniform coatings. The process enables production of electrically conductive films of improved and more consistent properties.

As generally described herein, the present disclosure provides a polymer film, which can be nanometers-thin (e.g., less than or equal to about 150 nm or about 100 nm) and/or have low surface roughness (e.g., RMS surface roughness of less than or equal to about 10 nm or about 5 nm). In various embodiments, the polymer films generally comprise an electrochemically polymerized polymer and a polyelectrolyte.

The methods for preparing polymer films described herein can provide nanometers-thin and uniformly thick polymer films, in part, due to the use of a self-assembled monolayer of a polyelectrolyte (e.g., a lubricin) to control polymer growth during electropolymerization.

In addition, multilayered polymer films comprising two or more of the nanometers-thin and uniformly thick polymer films described herein and methods of preparing said multilayered polymer films are provided.

### Definitions

To facilitate an understanding of the present disclosure, a number of terms and phrases are defined below.

Unless defined otherwise, all technical and scientific terms used herein have the same meaning as commonly understood by one of ordinary skill in the art to which these invention(s) belongs. The abbreviations used herein have their conventional meaning within the chemical and biological arts. The chemical structures and formulae set forth herein are constructed according to the standard rules of chemical valency known in the chemical arts.

The terms “a” and “an” as used herein mean “one or more” and include the plural unless the context is inappropriate.

In the application, where an element or component is said to be included in and/or selected from a list of recited elements or components, it should be understood that the element or component can be any one of the recited elements or components, or the element or component can be selected from a group consisting of two or more of the recited elements or components.

Further, it should be understood that elements and/or features of a composition or a method described herein can be combined in a variety of ways without departing from the spirit and scope of the present invention, whether explicit or implicit herein. For example, where reference is made to a particular compound, that compound can be used in various embodiments of compositions of the present invention and/or in methods of the present invention, unless otherwise understood from the context. In other words, within this application, embodiments have been described and depicted in a way that enables a clear and concise application to be written and drawn, but it is intended and will be appreciated that embodiments may be variously combined or separated without parting from the present teachings and invention(s). For example, it will be appreciated that all features described and depicted herein can be applicable to all aspects of the invention(s) described and depicted herein.

It should be understood that the expression “at least one of” includes individually each of the recited objects after the expression and the various combinations of two or more of the recited objects unless otherwise understood from the context and use. The expression “and/or” in connection with three or more recited objects should be understood to have the same meaning unless otherwise understood from the context.

The use of the term “include,” “includes,” “including,” “have,” “has,” “having,” “contain,” “contains,” or “containing,” including grammatical equivalents thereof, should be understood generally as open-ended and non-limiting, for example, not excluding additional unrecited elements or steps, unless otherwise specifically stated or understood from the context.

Where the use of the term “about” is before a quantitative value, the present invention also includes the specific quantitative value itself, unless specifically stated otherwise. As used herein, the term “about” refers to a ±10% variation, a ±5% variation, or a ±1% variation from the nominal value (as appropriate for the particular variable), unless otherwise indicated or inferred from the context.

At various places in the present specification, values are disclosed in groups or in ranges. It is specifically intended that the description include each and every individual subcombination of the members of such groups and ranges. For example, an integer in the range of 0 to 40 is specifically intended to individually disclose 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and 40, and an integer in the range of 1 to 20 is specifically intended to individually disclose 1, 2, 3, 4, 5, 6, 7, 8, 9, 10, 11, 12, 13, 14, 15, 16, 17, 18, 19, and 20.

The use of any and all examples, or exemplary language herein, for example, “such as” or “including,” is intended merely to illustrate better the present invention and does not pose a limitation on the scope of the invention unless claimed. No language in the specification should be construed as indicating any non-claimed element as essential to the practice of the present invention.

As used herein, a “polyelectrolyte” refers to a material having a bristle component and an adhesive component, with an adhesive component located at or near one or more terminal ends of the polyelectrolyte. A polyelectrolyte generally has one bristle component and can have one or two adhesive components, although other variations on this general design are included. A polyelectrolyte, before being subjected to any electrical potential, has multiple ionic charges associated with it, usually due to chemical groups that form part of or are associated with the bristle component. After repeated CV cycles and polymerization reactions, a polyelectrolyte can become depleted or devoid of any ionic charges that were consumed during the electrochemical polymerization reactions. Thus, the polyelectrolyte in a polymer film comprising an electrochemically polymerized polymer and a polyelectrolyte may not possess any ionic charge.

As used herein, an “adhesive component” refers to the part or portion of a polyelectrolyte that associates and/or contacts with and/or binds to a surface, such as a substrate (e.g., a conductive substrate such as an electrode). An adhesive component facilitates the self-assembly of the polyelectrolytes on a surface and provides the stability to the monolayer of the polyelectrolyte film for subsequent use. An adhesive component can interact with a substrate via a covalent bond (e.g., a polar covalent bond, a nonpolar covalent bond), an ionic bond, a hydrogen bond, a van der Waals interaction (e.g., dipole-dipole interactions, London dispersion forces), a metallic bond, or a combination thereof. An adhesive component can have a first adhesive component and a second adhesive component. For example, the first and the second adhesive components at be at or near the terminal ends of a polyelectrolyte such that when adhered to a substrate the bristle forms a looped structure, whereby the height of the resulting monolayer of polyelectrolytes is about half the length of the bristle component.

As used herein, a “bristle component” refers to the part or the portion of a polyelectrolyte that is charged and in use, is substantially perpendicular or normal to the substrate on which the polyelectrolyte assembles. The bristle component can be a single strand, for example, a generally straight chained polymeric compound such as a nucleic acid, a protein, a polypeptide, a peptide nucleic acid, a synthetic polymer, and combinations thereof. The bristle component can form a looped structure if the polyelectrolyte of which it is a part has two adhesive components at each of its ends or termini. A bristle component can be branched, i.e., have strands that emanate from a central strand, where the branched strands tend to be shorter than the main or central strand. The bristle component includes one or more ionic functional groups or ionic charges that are used in the electropolymerization process. The bristle component can have greater than 25, 50, 75, 100, 150, or 200 ionic charges (e.g., these number of anionic or cationic charges per polyelectrolyte molecule).

As used herein, Proteoglycan 4 (PRG4), also known as lubricin, megakaryocyte stimulating factor (MSF) or superficial zone protein (SZP) is a ubiquitous, endogenous glycoprotein that coats the articulating surfaces of the body, acting as a lubricant. The terms “PRG4”, “MSF”, and “lubricin” are used interchangeably herein. PRG4 was first isolated from synovial fluid and demonstrated lubricating ability in vitro similar to synovial fluid at a cartilage-glass interface and in a latex-glass interface. It was later identified as a product of synovial fibroblasts. Lubricin is highly surface active molecule (e.g., holds onto water) and acts as a potent cytoprotective, anti-adhesive and boundary lubricant. PRG4 has been shown to be present inside the body at the surface of synovium, tendon, articular cartilage such as meniscus, and in the protective film of the eye, among other sites, and plays an important role in joint lubrication and synovial homeostasis.

PRG4 is encoded by the megakaryocyte stimulating factor (MSF) gene, also known as the proteoglycan 4 (PRG4) gene. (See, e.g., NCBI Accession Number AK131434 and U70136). The gene encoding naturally-occurring full length lubricin contains 12 exons, and the naturally-occurring MSF gene product, i.e., lubricin contains 1,404 amino acids (including the signal sequence) with multiple polypeptide sequence homologies to vitronectin including hemopexin-like and somatomedin-like regions. The full length amino acid sequence of human lubricin is provided as SEQ ID NO:1 (residues 1-1404).

PRG4 has a long, central mucin-like domain located between terminal protein domains that is critical for its lubricating ability. This mucin-like domain is encoded by Exon 6 of the MSF gene and made up of residues 200-1140 of the 1404 amino acid polypeptide; it is rich in O-linked glycosylation, and particularly O-linked β (1-3) Gal-GalNAc oligosaccharides. The domain contains multiple repeats of the amino acid sequence KEPAPTT (SEQ ID NO:3) (and variations thereof). This series of repeats is conserved in lubricins across mammalian species; in all mammals investigated, lubricin contains multiple repeats of an amino acid sequence which is at least 50% identical to KEPAPTT (SEQ ID NO:3) and is rich in proline and/or threonine residues. The proline and threonine residues serve as glycosylation points, with at least one threonine being glycosylated in most repeats. The threonine anchored O-linked sugar side chains are critical for lubricin's boundary lubricating function. The side chain moiety typically is a β(1-3)Gal-GalNAc moiety, with the β(1-3)Gal-GalNAc typically capped with sialic acid or N-acetylneuraminic acid. The extensive O-linked glycosylation in the mucin-like domain is responsible for PRG4's boundary lubricating and dis-adhesive properties at various biointerfaces in the body including articular cartilage, tendons, the pericardium, and the ocular surface (Jay et al., Matrix Biol., 2014; 39:17-24). Lubricin also contains N-linked oligosaccharides.

The exon boundaries of PRG4 are provide in Table 1 below. Exon 1 encodes the signal sequence of the protein which is cleaved from the polypeptide to form the mature form of the protein. The full length mature human lubricin is therefore residues 25-1404 of SEQ ID NO:1. The amino acid sequence of the protein backbone of lubricin may differ depending on alternative splicing of exons of the human MSF gene. A known splice variant of human lubricin includes only Exons 2 and 4-12, but not exons 1 (the signal sequence) and exon 3. Recombinant variants including only Exon 6; or Exon 6 with part or all of Exon 7, 8 and/or 9; or Exons 6-12; or Exons 6-9; or Exons 2 and 4-9 are disclosed in U.S. Pat. No. 6,743,774, incorporated by reference herein in its entirety for all purposes. Another recombinant form of lubricin missing 474 amino acids from the central mucin domain has been reported that maintained lubricin's lubricating ability, although somewhat attenuated (Flannery et al., Arthritis Rheum 2009; 60 (3): 840-7).

PRG4 has been shown to exist not only as a monomer but also as a dimer and multimer disulfide-bonded through the conserved cysteine-rich domains at both N- and C-termini. Methods of recombinant human PRG4 production are disclosed in U.S. Pat. No. 10,125,180, which is incorporated by reference herein in its entirety for all purposes, where the recombinant lubricin species has a final apparent molecular weight of 450-600 kDa, with polydisperse multimers frequently measuring at 1,000 kDa or more, as estimated by comparison to molecular weight standards on SDS tris-acetate 3-8% polyacrylamide gels, and where of the total glycosylations, about half comprise two sugar units (GalNAc-Gal), and half comprise three sugar units (GalNAc-Gal-Sialic acid).

TABLE 1
Exon Boundaries of Lubricin (PRG4)

| | Residues in Amino Acid | Nucleotides in Nucleotide |
|---|---|---|
| Exon | Sequence of SEQ ID NO: 1 | Sequence of SEQ ID NO: 2 |
| 1 | 1-24, inclusive | 34-105, inclusive |
| 2 | 25-66, inclusive | 106-231, inclusive |
| 3 | 67-104, inclusive | 232-345, inclusive |
| 4 | 105-155, inclusive | 346-498, inclusive |
| 5 | 156-199, inclusive | 499-630, inclusive |
| 6 | 200-1140, inclusive | 631-3453, inclusive |
| 7 | 1141-1167, inclusive | 3454-3534, inclusive |
| 8 | 1168-1212, inclusive | 3535-3670, inclusive |
| 9 | 1213-1263, inclusive | 3671-3822, inclusive |
| 10 | 1264-1331, inclusive | 3823-4026, inclusive |
| 11 | 1332-1371, inclusive | 4027-4146, inclusive |
| 12 | 1372-1404, inclusive | 4147-4245, inclusive |

Throughout the description, where compositions and kits are described as having, including, or comprising specific components, or where processes and methods are described as having, including, or comprising specific steps, it is contemplated that, additionally, there are compositions and kits of the present invention that consist essentially of, or consist of, the recited components, and that there are processes and methods according to the present invention that consist essentially of, or consist of, the recited processing steps.

As a general matter, compositions specifying a percentage are by weight unless otherwise specified. Further, if a variable is not accompanied by a definition, then the definition of the variable elsewhere herein controls.

### Polymer Films

As described herein, in one aspect, the present disclosure provides polymer films that can have uniform thickness and/or low surface roughness as well as being conductive and/or optically transparent. In various embodiments, a polymer film generally comprises an electrochemically polymerized polymer. In certain embodiments, a polymer film comprises an electrochemically polymerized polymer and a polyelectrolyte, where the polyelectrolyte is present in the polymer layer due to its facilitation of the electropolymerization process. Further, depending on the degree of polymerization, the polyelectrolyte may no longer possess an ionic charge.

In some embodiments, a second polymer can be electrochemically polymerized in the pores of the first electrochemically polymerized polymer to provide a composite polymer film. In a composite polymer film, the first electrochemically polymerized polymer and the second electrochemically polymerized polymer can be interpenetrating and continuous. Further, the dimensions and morphology, for example, thickness and surface roughness of the composite polymer film can be similar to those of a polymer film as described herein.

It should be understood that reference to a “polymer film” also includes reference to a “composite polymer film,” which terms can be used interchangeably herein unless understood differently from the context.

In various embodiments, a polymer film described herein has a thickness of about 5 nm to about 150 nm. In certain embodiments, a polymer film described herein has a thickness from about 1 nm to less than or equal to about 5 nm, about 10 nm, about 20 nm, about 30 nm, about 40 nm, about 50 nm, about 60 nm, about 70 nm, about 80 nm, about 90 nm, about 100 nm, about 110 nm, about 120 nm, about 130 nm, about 140 nm, or about 150 nm. In particular embodiments, a polymer film described herein has a thickness of between about 50 nm to about 110 nm. In some embodiments, a polymer film described herein has a thickness of between about 50 nm to about 110 nm. In some embodiments, a polymer film described herein has a thickness of less than or equal to about 100 nm. The thickness of the polymer film can be controlled, in part, by the thickness and density of the monolayer of the polyelectrolytes.

In various embodiments, a polymer film described herein has a RMS surface roughness of about 1 nm to about 10 nm. In certain embodiments, a polymer film described herein has a RMS surface roughness of less than or equal to about 1 nm, about 2 nm, about 3 nm, about 4 nm, about 5 nm, about 6 nm, about 7 nm, about 8 nm, about 9 nm, or about 10 nm. In certain embodiments, a polymer film described herein has a RMS surface roughness of less than or equal to about 5 nm.

In various embodiments, a polymer film described herein further comprises a polyelectrolyte. For example, a polymer film can include an electrochemically polymerized polymer; and a polyelectrolyte. Such a polymer film can have a thickness of less than or equal to about 100 nm and/or a RMS surface roughness of less than or equal to about 5 nm.

In various embodiments, the polymer film is nanoporous. For example, the total porosity of the polymer film including a composite polymer film can be from 10% to about 90%, such as about 20% to about 80%, about 20% to about 70%, about 20% to about 60%, about 30% to about 80%, about 40% to about 80%, about 40% to about 90%, about 50% to about 70%, and about 50% to about 80%. In certain embodiments, the total porosity of the polymer film is from 60% to about 80%. Porosity can be determined by various methods but ellipsometry measurements are preferred and currently believed to be a reliable method using both film thickness and refractive index.

In certain embodiments, the pore size distribution of pores of the polymer film is from 5 nm to about 120 nm. In particular embodiments, the pore size distribution of pores of the polymer film is from about 10 nm to about 80 nm.

The pore structure and interconnectivity of the pores of an electrochemically polymerized polymer formed in the presence of and around and along a polyelectrolyte of the present disclosure will provide a tortuosity factor for the pores. The tortuosity factor (t), may be defined as the diffusional pathlength (LD) along the film thickness axis divided by the thickness of the film (T), i.e. t=LD/T. In certain embodiments, the polymer film has a tortuosity factor from about 1 to about 10. Tortuosity can be calculated using the electrochemical cell method. See, e.g., Nguyen, T T., Demortière, A., Fleutot, B. et al. “The electrode tortuosity factor: why the conventional tortuosity factor is not well suited for quantifying transport in porous Li-ion battery electrodes and what to use instead,” npj Computational Materials 6, 123 (2020). Further, this pore structure and interconnectivity of a first polymer of a polymer film presents the possibility of making a composite polymer film as described therein.

In various embodiments, the polymer film is a conductive polymer film. In such embodiments, the electrochemically polymerizable polymer can be polypyrrole, poly(thiophene), poly(3,4-ethylene dioxythiophene), poly(p-aminobenzene sulfonic acid), polyaniline, poly(dichlorophenolindophenol), poly(pyrrole-benzophenone), poly(p-phenylene vinylene), poly(p-phenylene), poly(2-mercaptobenzimidazole), or a combination thereof.

In some embodiments, the polymer film has a conductivity from about 0.1 S/cm to about 100 S/cm, such as from about 0.5 S/cm to about 100 S/cm, about 1 S/cm to about 100 S/cm, about 5 S/cm to about 100 S/cm, about 10 S/cm to about 100 S/cm, about 15 S/cm to about 100 S/cm, about 20 S/cm to about 100 S/cm, about 25 S/cm to about 100 S/cm, about 30 S/cm to about 100 S/cm, about 35 S/cm to about 100 S/cm, about 40 S/cm to about 100 S/cm, about 45 S/cm to about 100 S/cm, about 50 S/cm to about 100 S/cm, about 55 S/cm to about 100 S/cm, about 60 S/cm to about 100 S/cm, about 65 S/cm to about 100 S/cm, about 70 S/cm to about 100 S/cm, about 75 S/cm to about 100 S/cm, about 80 S/cm to about 100 S/cm, about 85 S/cm to about 100 S/cm, about 90 S/cm to about 100 S/cm, and about 95 S/cm to about 100 S/cm. In certain embodiments, the polymer film has a conductivity from about 10 S/cm to about 110 S/cm.

In various embodiments, the polymer film has an optical transmission in the visible light wavelengths from about 60% to about 100%, for example, from about 75% to about 100%, about 80% to about 100%, about 90% to about 100%, and about 95% to about 100%. In certain embodiments, the polymer film has an optical transmission greater than about 80%, about 85%, about 90%, or about 95%, in the visible light wavelengths. In some embodiments, the polymer film has an optical transmission in the visible light wavelengths from about greater than about 90%, or in a ranges of about 90% to about 97%. The optical transmission (optical transparency) can be determined using ultra-violet/visible light spectroscopy. For example, a multi-wavelength light source can be shone through a polymer film described herein and the absorption of light at each wavelength measured. The inverse of the measured absorption is the optical transmission.

In some embodiments, the polymer film is a non-conductive polymer film. In such embodiments, the electrochemically polymerizable polymer can be poly(2-methoxy-5-(2′-ethylhexyloxy)-p-phenylene vinylene), poly(allylamine) hydrochloride, poly-(diallyldimethylammonium) chloride, poly(o-phenylenediamine), or a combination thereof.

In certain embodiments, the polymer film further comprises a second electrochemically polymerized polymer. In certain embodiments, the second electrochemically polymerized polymer is located within the pores of the polymer film. In certain embodiments, the second electrochemically polymerized polymer can be any of the electrochemically polymerized polymers described herein or known in the art.

In certain embodiments, the polymer film further comprises a cationic compound, an anionic compound, a neutral compound, or a combination thereof. In certain embodiments, the cationic compound, the anionic compound, and/or the neutral compound is a therapeutic agent.

### Methods of Making Polymer Films

As described herein, in one aspect, the present disclosure provides methods of preparing the polymer films described herein. The methods generally include:
(a) contacting a solution comprising a plurality of one or more monomers with a monolayer of a polyelectrolyte coated on a substrate; and
(b) applying one or more cycling voltammetry (CV) cycles to the solution to form the polymer film.

In various embodiments, the resulting polymer film has a thickness of less than or equal to about 200 nm, about 150 nm, or about 100 nm and/or a RMS surface roughness of less than or equal to about 10 nm or about 5 nm.

In certain embodiments, the monolayer of the polyelectrolyte coated on a substrate is prepared by contacting the substrate with a buffer solution comprising the polyelectrolyte. In various embodiments, the concentration of the polyelectrolyte in the buffer solution is from about 50 mg mL⁻¹ to about 150 mg mL⁻¹. In certain embodiments, the concentration of the polyelectrolyte in the buffer solution is about 100 mg mL⁻¹.

The polyelectrolyte acts as a dopant such that when in the presence of electrochemically polymerizable monomers and an electric potential (CV cycle) is applied, nucleation occurs at the location of the ionic charges along the polyelectrolytes facilitating electrochemically catalyzed polymerization of the monomers along the polyelectrolyte bristles. When additional CV cycles are applied, polymerization is initiated again and the polymer continues to grow along and between and encapsulating the bristles. During repeated CV cycles, the growing polymer film usually begins to compress the monolayer of polyelectrolytes, forming a substantially uniform thickness across the substrate. With repeated application of CV cycles, the polymer film is formed having the properties as described herein. As should be understood, the number, length and intensity, among other factors, influence the properties of the final polymer film.

A polymer film of the present disclosure typically includes a polyelectrolyte. In certain embodiments, the polyelectrolyte can be removed from the polymer film. Nevertheless, it should be understood that a polyelectrolyte used in the formation of an electrochemically polymerized polymer has properties, features and characteristics that can be changed and/or lost, for example, consumed during formation of the polymer film (e.g., number of ionic charges associated with the polyelectrolyte, height of the monolayer of polyelectrolyte, and porosity and diffuse nature of the polyelectrolyte). More specifically, a polyelectrolyte, before being subjected to any electrical potential, has multiple ionic charges associated with it, usually due to chemical groups that form part of or are associated with the bristle component. However, after repeated CV cycles and polymerization reactions, a polyelectrolyte can become devoid of any ionic charge as being consumed during the electrochemical polymerization reactions.

Accordingly, it should be understood that the following description and properties, features and characteristics of a polyelectrolyte can be more applicable to the methods of making the polymer films as described herein, but those properties, features and characteristics may not be present in the resulting polymer film where the polyelectrolyte remains present.

As described herein, a polyelectrolyte can generally refer to a material having a bristle component and an adhesive component, where multiple ionic charges such as anionic charges or cationic charges are present on or are part of the bristle component.

The adhesive component is the part or portion of a polyelectrolyte that can associate with and/or contact and/or bind to a surface, such as of a substrate. The adhesive component can facilitate the self-assembly of the polyelectrolytes on a surface and provides the stability for the polyelectrolyte coating for subsequent use. An adhesive component can interact with a substrate via a variety of mechanisms, for example, via a covalent bond, an ionic bond, a hydrogen bond, a van der Waals interaction, a metallic bond, or a combination thereof. After formation of a polymer film, it can remain associated with and/or in contact with and/or bound to the surface of a substrate.

A polyelectrolyte generally has one bristle component and can have one or two adhesive components, although other variations on this general scheme are possible. In various embodiments, the polyelectrolyte can be a triblock polymer, a diblock polymer, or an end-grafted polymer. The bristle component can be a single strand, which can form a looped structure if part of a polyelectrolyte having two adhesive components at each of its ends or termini. The single strand of a polyelectrolyte can be generally straight chained polymeric compound such as a nucleic acid, a protein, a polypeptide, a peptide nucleic acid, a synthetic polymer, and combinations thereof.

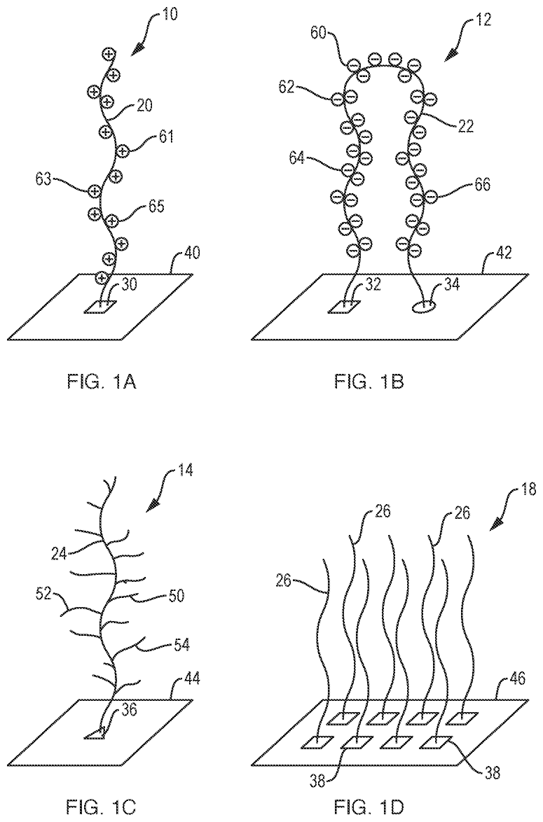

As shown in FIG. 1A, the polyelectrolyte 10 has one bristle component 20 and one adhesive component 30 associated with a substrate 40. The polyelectrolyte 12 shown in FIG. 1B also has one bristle component 22 but two adhesive components 32,34 associated with a substrate 42. In each case, the first adhesive component and the second adhesive component, when present, are located at or near the terminal ends of a polyelectrolyte, which permits the bristle component to orient itself in a direction normal or perpendicular to the substrate surface as generally shown. In the case of the polyelectrolyte with two adhesive components in FIG. 1B, when they are adhered to a substrate, the bristle forms a looped structure, whereby the height of the resulting polyelectrolyte layer is about half the length of the entire bristle component.

A bristle component can be branched, i.e., have strands that emanate from a central strand, where the branched strands tend to be shorter than the main or central strand. For example, the bristle component can include one or more monomers, wherein the one or more monomers form a bristle side chain. Monomers include, but are not limited to, ethylene glycol, carboxybetainethiophene, carboxybetaine methacrylate, ethylenedioxythiophene, ethylenedioxythiophene-phosphorylcholine, ethylenedioxythiophene-carboxybetaine, ethylenedioxythiophene-sulfobetaine, ethylenedioxythiophene-tri (ethylene glycol), ethylenedioxythiophene-mannose, ethylenedioxythiophene-hydroquinone, ethylenedioxythiophene-phenylboronic acid, (3,4-ethylenedioxythiophene)-methyl 2-bromopropanoate, oligo (ethylene glycol) methacrylate, and poly([2-(methacryloyloxy)ethyl]dimethyl-(3-sulfopropyl) ammonium. FIG. 1C depicts a polyelectrolyte 14 having a bristle component 24 with exemplary branched strands 50,52,54. The polyelectrolyte also includes one adhesive component 36 associated with a substrate 44.

The bristle component typically includes one or more ionic functional groups or ionic charges that are used in the electropolymerization process. The bristle component of a polyelectrolyte typically can be anionicly charged (i.e., contain anionic functional groups and/or charges), or cationicly charged (i.e., contain cationic functional groups and/or charges). That is, the ionic charges of the polyelectrolyte are usually due to the chemical functional groups present on, associated with, and/or forming the bristle component. For example, the bristle component can include one or more chemical functional groups selected from the group consisting of a hydroxyl group, a carbohydrate moiety, a zwitterionic group, and a combination thereof. Referring back to FIG. 1B, multiple anionic charges 60,62,64,66 are located on or associated with the bristle component 22; while in FIG. 1A, multiple cationic charges are present 61,63,65 on the polyelectrolyte 20. The bristle component can have greater than 25, 50, 75, 100, 150, or 200 ionic charges (where these numbers refer to the number of ionic charges per polyelectrolyte molecule).

As already mentioned, in use, the bristle component generally can orient itself substantially perpendicular or normal to the substrate on which the polyelectrolyte assembles, for example, to which it is adhered (as generally shown in FIGS. 1A-1C). The self-assembly of a polyelectrolyte onto a surface can provide the telechelic brush layer, in which the ionic charges of the bristle component are available for the electropolymerization of the monomers in solution contacting the monolayer of polyelectrolytes. FIG. 1D shows a plurality of polyelectrolytes 26 associated with a substrate 46 via their singular adhesive components 38 (note that the ionic charges are not shown in the figure so as not to clutter the figure; however, it should be understood that charges such as shown in FIGS. 1A and 1B are present along the bristle component. As such, FIG. 1D depicts a monolayer of polyelectrolytes 18, which self-assembled to form a brush-like structure on the substrate having a substantially constant thickness and density across the substrate, where the ionic charges (not shown) along the bristle components are ready for electrochemical polymerization.

When a large number of ionic charges are present, many CV cycles can be applied to grow the polymer film to its desired properties, for example, fewer CV cycles for a less dense, more porous polymer film, while more CV cycles can create a denser, lesser porous polymer film. Consequently, these factors should be considered particularly when a composite polymer film is to be made. More specifically, in various embodiments, the bristle component comprises from about 25 to about 250 anionic charges, or more, per polyelectrolyte molecule. In certain embodiments, the bristle component comprises from about 100 to about 200 anionic charges per polyelectrolyte molecule.

In various embodiments, the bristle component comprises from about 50 to about 250 glycosylation sites per polyelectrolyte molecule. In some embodiments, the bristle component comprises from about 100 to about 200 glycosylation sites per polyelectrolyte molecule.

In certain embodiments, the bristle component is the mucin domain of a lubricin. In certain embodiments, the mucin domain has homology with the amino acid sequence of encoded by Exon 6 of PRG4. In certain embodiments, the mucin domain has 100%, 99.0%98.0%97.0%, 96.0%, 95.0%, 94.0%, \93.0%, 92.0, 91.0%, 90.0%, 89.088.0%, 87.0%, 86.0%, 85.0%, 84%, 83%, 82%, 81%, 80%, 79%, 78%, 77%, 76%, 75%, 74%, 73%, 72%, 71%, 70%, 65%, 60%, 55%, or 50% amino acid sequence homology with the amino acid residues of Exon 6 of the MSF gene, e.g., with amino acid residues 200-1140 of SEQ ID NO:1. In certain embodiments, the adhesive component is an adhesive globular end domain of a lubricin.

In certain embodiments, the adhesive component comprises a first adhesive component and a second adhesive component.

In certain embodiments, the first adhesive component is the N terminus globular end domain of a lubricin. In certain embodiments, the N terminus globular end domain has homology with exons 2-5 of PRG4. In certain embodiments, the N terminus globular end domain, i.e., a region having homology with amino acids encoded by exons 7, 8, 9, 10, 11, and/or 12 of the MSF gene, where the residues are modified by substitution, deletion, or insertion to reduce or increase the length of the sequence, while maintaining an appropriate charge density to initiate and sustain the propagation polymerization reaction. In certain embodiments, the N terminus globular end domain has 100%, 99.0%, 98.0%, 97.0%, 96.0%, 95.0%, 94.0%, 93.0%, 92.0%, 91.0%, 90.0%, 89.0%, 88.0%, 87.0%, 86.0%, 85.0%, 84%, 83%, 82%, 81%, 80%, 79%, 78%, 77%, 76%, 75%, 74%, 73%, 72%, 71%, 70%, 65%, 60%, 55%, or 50% amino acid sequence homology with the amino acid residues of Exons 2-5 of the MSF gene, e.g., with amino acid residues 25-199 of SEQ ID NO:1.

In certain embodiments, the second adhesive component is the C terminus globular end domain of a lubricin. In certain embodiments, the C terminus globular end domain has homology with exons 7-12 of PRG4. In certain embodiments, the C terminus globular end, i.e., a region having homology with amino acids encoded by exons 2, 3, 4 and/or 5 of the MSF gene, where the residues are modified by substitution, deletion, or insertion to reduce or increase the length of the sequence, while maintaining an appropriate charge density to initiate and sustain the propagation polymerization reaction. In certain embodiments, the C terminus globular end domain has 100%, 99.0%, 98.0%, 97.0%, 96.0%, 95.0%, 94.0%, 93.0%, 92.0%, 91.0%, 90.0%, 89.0%, 88.0%, 87.0%, 86.0%, 85.0%, 84%, 83%, 82%, 81%, 80%, 79%, 78%, 77%, 76%, 75%, 74%, 73%, 72%, 71%, 70%, 65%, 60%, 55%, or 50% amino acid sequence homology with the amino acid residues of Exons 7-12 of the MSF gene, e.g., with amino acid residues 1141-1404 of SEQ ID NO:1.

In certain embodiments, the polyelectrolyte is a triblock polymer. In certain embodiments, the triblock polymer is a naturally occurring triblock polymer, a synthetic triblock polymer, or a combination thereof.

In certain embodiments, the triblock polymer is a lubricin. In certain embodiments, the lubricin is a recombinant human lubricin disclosed in U.S. Pat. No. 10,125,180, which has the amino acid sequence of residues 25-1404 of SEQ ID NO: 1. This species includes the central exon (Exon 6) comprising repeats of the sequence KEPAPTT (SEQ ID NO: 3) variously glycosylated with O-linked β (1-3)Gal-GalNAc oligosaccharides, as well as N- and C-terminal sequences with homology to vitronectin. In certain embodiments, the lubricin has 100%, 99.0%, 98.0%, 97.0%, 96.0%, 95.0%, 94.0%, 93.0%, 92.0%, 91.0%, 90.0%, 89.0%, 88.0%, 87.0%, 86.0%, 85.0%, 84%, 83%, 82%, 81%, 80%, 79%, 78%, 77%, 76%, 75%, 74%, 73%, 72%, 71%, 70%, 65%, 60%, 55%, or 50% amino acid sequence homology with amino acid residues 25-1404 of SEQ ID NO:1.

In certain embodiments, the lubricin include one or more native or recombinant PRG4 proteins, isoforms, or splice variants as described herein or disclosed in U.S. Pat. Nos. 6,433,142; 6,743,774; 6,960,562; 7,030,223, and 7,361,738, each of which is incorporated by reference herein in its entirety for all purposes. In certain embodiments, the lubricin includes a central mucin-like domain having homology with the amino acid sequence of encoded by Exon 6 of PRG4, as well as N- and C-terminal sequences having homology with exons 2-5 and 7-12, respectively.

Homology or identity between sequences may be determined in various ways that are within the skill in the art, for instance, using publicly available computer software such as BLAST, BLAST-2, ALIGN or Megalign (DNASTAR) software. BLAST (Basic Local Alignment Search Tool) analysis using the algorithm employed by the programs blastp, blastn, blastx, tblastn and tblastx (Karlin et al., (1990) PROC. NATL. ACAD. SCI. USA 87, 2264-2268; Altschul, (1993) J. MOL. EVOL. 36, 290-300; Altschul et al., (1997) NUCLEIC ACIDS RES. 25, 3389-3402, incorporated by reference) are tailored for sequence similarity searching.

In certain embodiments, the lubricin includes at least the sequence encoded by Exon 6 of the MSF gene where the amino acid sequence encoded by Exon 6 is modified by reducing the number of repeats of the KEPAPTT-repeat domain. In reducing the number of repeats, about 100 to about 250 anionic charges, about 150 to about 250 anionic charges, about 200 to about 250 anionic charges, about 100 to about 200 anionic charges, about 100 to about 150 anionic charges, or about 150 to about 200 anionic charges must be maintained in the mucin domain. In reducing the number of repeats, sufficient charge density should be maintained in the central-mucin like domain. For example, in one embodiment, one or more KEPAPTT repeat domains are deleted from the amino acid sequence encoded by Exon 6 such that it is reduced in length; however, the sequence retains sufficient glycosylation sites (e.g., about 100 to about 250 glycosylation sites, about 150 to about 250 glycosylation sites, about 200 to about 250 glycosylation sites, about 100 to about 200 glycosylation sites, about 100 to about 150 glycosylation sites, or about 150 to about 200 glycosylation sites), such as proline and/or threonine residues, such that charge density from resulting glycosylation can be maintained within a range of about 0.005 charges/nm³ to about 0.1 charges/nm³.

In certain embodiments, the amino acid sequence encoded by Exon 6 is modified by changing the sequence in one or more of the KEPAPTT-repeat domain. For example, one or more point mutations may be made to the amino acid sequence encoded by one or more of the KEPAPTT sequences within the domain to delete one or more residues or substitute one or more residues with another residue. In making substitutions or deletions, about 100 to about 250 anionic charges, about 150 to about 250 anionic charges, about 200 to about 250 anionic charges, about 100 to about 200 anionic charges, about 100 to about 150 anionic charges, or about 150 to about 200 anionic charges must be maintained in the mucin domain. In reducing the number of repeats, sufficient charge density should be maintained in the central-mucin like domain.

In certain embodiments, one or more residues are deleted from the amino acid sequence encoded by Exon 6 such that it is reduced in length, or one or more point mutations are made; however, the sequence retains sufficient glycosylation sites (e.g., about 100 to about 250 glycosylation sites, about 150 to about 250 glycosylation sites, about 200 to about 250 glycosylation sites, about 100 to about 200 glycosylation sites, about 100 to about 150 glycosylation sites, or about 150 to about 200 glycosylation sites), such as proline and/or threonine residues, such that charge density from resulting glycosylation can be maintained within a range of about 0.005 charges/nm³ to about 0.1 charges/nm³.

Methods for isolation, purification, and recombinant expression of a proteins such as PRG4 protein are well known in the art. In certain embodiments, the method starts with cloning and isolating mRNA and cDNA encoding PRG4 proteins or isoforms using standard molecular biology techniques, such as PCR or RT-PCR. The isolated cDNA encoding the PRG4 protein or isoform is then cloned into an expression vector, and expressed in a host cell for producing recombinant PRG4 protein, and isolated from the cell culture supernatant. A method for production of recombinant human PRG4 is provided in U.S. Pat. No. 10,125,180, which is incorporated by reference herein its entirety for all purposes.

In some embodiments, the substrate is incubated in the buffer solution comprising the polyelectrolyte for about 5 minutes to about 45 minutes. In certain embodiments, the substrate is incubated in the buffer solution comprising the polyelectrolyte for about 10 minutes. In particular embodiments, the substrate is incubated in the buffer solution comprising the polyelectrolyte for about 30 minutes.

In various embodiments, the substrate comprises a conductive surface. In particular embodiments, the conductive surface is a gold surface, a platinum surface, a carbon surface, a titanium surface, a polypyrrole surface, a poly(thiophene) surface, a poly(3,4-ethylene dioxythiophene) surface, a poly(p-aminobenzene sulfonic acid) surface, a polyaniline surface, a poly(dichlorophenolindophenol) surface, a poly(pyrrole-benzophenone) surface, a poly(p-phenylene vinylene) surface, a poly(p-phenylene) surface, a poly(2-mercaptobenzimidazole) surface, an indium tin oxide surface, or a combination thereof.

In various embodiments, the electrochemically polymerizable monomer is pyrrole, 3,4-ethylene dioxythiophene, aniline, 2,6-dichloroindophenol, pyrrole-benzophenone, p-phenylene vinylene, p-phenylene, 2-mercaptobenzimidazole, 2-methoxy-5-(2′-ethylhexyloxy)-p-phenylene vinylene), allylamine hydrochloride, diallyldimethylammonium chloride, o-phenylenediamine, or a combination thereof.

In some embodiments, the concentration of each of the one or more monomers in the solution is from about 0.001 M to about 0.5 M. In certain embodiments, the concentration of each of the one or more monomers in the solution is about 0.01 M. In particular embodiments, the concentration of each of the one or more monomers in the solution is about 0.2 M.

In some embodiments, the solution comprising the plurality of one or more monomers is an aqueous solution. In certain embodiments, the monomers are in a nonionic solution. In various embodiments, the buffer solution is a PBS solution.

In various embodiments, the thickness of the monolayer of the polyelectrolyte on the substrate is less than or equal to about 100 nm. In some embodiments, the thickness of the monolayer of the polyelectrolyte on the substrate is about 50 nm to about 150 nm. In particular embodiments, the thickness of the monolayer of the polyelectrolyte on the substrate is less than about 50 nm, about 60 nm, about 70 nm, about 75 nm, about 80 nm, about 90 nm, about 100 nm, about 110 nm, about 120 nm, about 125 nm, about 130 nm, about 140 nm, about 150 nm, about 170 nm, about 190 nm, or about 210 nm. As described herein, the thickness of the monolayer, among other factors, influences the thickness of the resulting polymer film after being subjected to a number of cycling voltammetry (CV) cycles. Accordingly, when designing a polyelectrolyte, its resulting thickness when formed in a monolayer on a substrate is a factor to be considered to provide the desired thickness of the resulting polymer film.

In certain embodiments, the density of the polyelectrolyte on the substrate is from about 100 ng/cm² to about 5000 ng/cm². In various embodiments, the density of the polyelectrolyte on the substrate is greater than about 100 ng/cm², about 200 ng/cm², about 300 ng/cm², about 400 ng/cm², about 500 ng/cm², about 700 ng/cm², about 900 ng/cm², about 1000 ng/cm², about 1200 ng/cm², about 1500 ng/cm², about 2000 ng/cm², about 2500 ng/cm², about 3500 ng/cm², or about 5000 ng/cm².

In various embodiments, the polyelectrolyte monolayer has a diffuse structure. In some embodiments, the polyelectrolyte monolayer comprises greater than about 90%, about 92%, about 94%, about 96%, greater than about 98%, or greater than about 99% water.

In certain embodiments, the polyelectrolyte is a lubricin described herein.

In various embodiments, 1 to 50 CV cycles is applied to the solution to polymerize the monomers. In certain embodiments, 1 to 35 CV cycles is applied to the solution. In particular embodiments, 5 CV cycles, 10 CV cycles, 15 CV cycles, 20 CV cycles, 25 CV cycles, 30 CV cycles, 35 CV cycles, 40 CV cycles, 45 CV cycles, or 50 CV cycles is applied to the solution.

In various embodiments, the one or more CV cycles is applied to the solution using a cycling potential from about −1.0 V to about +1.1 V. In some embodiments, the one or more CV cycles is applied to the solution using a cycling potential from about −0.1 V to about +1.1 V. In certain embodiments, the one or more CV cycles are applied to the solution using a cycling potential from about −0.8 V to about +0.8 V. In particular embodiments, the one or more CV cycles are applied to the solution using a cycling potential from about −0.6 V to about +1.1 V.

In various embodiments, the cycling potential is applied using a scan rate of from about 1 mV s⁻¹ to about 10 mV s⁻¹. In some embodiments, the cycling potential is applied using a scan rate of about 5 mV s⁻¹.

In various embodiments, the polymer film has a nanoporous structure. For example, the nanoporous structure of the polymer film, if of a first polymer, can be used to polymerize a second polymer in the nanopores of the first polymer, which can result in a composite polymer film. In some embodiments, a method of making a composite polymer film as described herein further comprises contacting a solution comprising a second plurality of one or more electrochemically polymerizable monomers with the already formed polymer of the polymer film, wherein the second plurality of one or monomers is chemically different from the plurality of one or more monomers to form the already formed polymer (e.g., the chemical structure of the monomers is different); and applying one or more CV cycles to the solution to form a second polymer in the pores of the first polymer to provide a composite polymer film.

Practicing these additional steps of the method can produce a composite polymer film as described herein.

In some embodiments, the method further comprises removing the polymer film from the substrate.

### Methods of Making Multilayered Polymer Films

As described herein, in one aspect, the present disclosure provides methods for preparing a multilayered polymer film as described herein, for example, a first polymer film and a second polymer film in contact with the first polymer film, which polymer films can be composite polymer films. The first polymer film can be of the same polymer as the second polymer film, but the first polymer film can be a different polymer than the second polymer film of the multilayered polymer film.

In various embodiments, the methods generally include preparing a first layer of a polymer film using the methods as described herein; and disposing a second layers of a polymer film onto the first layer to form a multilayered polymer film. Additional layers of a polymer film, the same or different than the first and second polymer films, can be subsequently added.

In certain embodiments, disposing the second layer of a polymer film onto the first layer comprises creating a monolayer of the polyelectrolyte coated on a surface of the first polymer film; contacting a solution comprising a plurality of one or more monomers with the monolayer of the polyelectrolyte; and applying one or more CV cycles to the solution to form the second layer of a polymer film.

In various embodiments, the same components, reagents, conditions, and other parameters and variables as described herein for creating a polymer film are equally applicable and compatible here for a multilayered polymer film, for example, the density, diffuse and chemical structure of the polyelectrolyte, the thickness of the monolayer, the concentration and incubation time of the polyelectrolyte, chemical structure and concentration of electrochemically polymerizable monomers, number of CV cycles, the cycling potential, and the cycling potential applied using a scan rate, among others that are not repeated here for brevity.

### Multilayered Polymer Films

As described herein, in one aspect, the present disclosure provides multilayered polymer films. In various embodiments, a multilayered polymer film generally comprises two or more layers of a polymer film as described herein. In certain embodiments, a multilayered polymer film comprises 2, 3, 4, 5, 6, 7, 8, 9, 10, 11, 12, 13, 14, 15, 16, 17, 18, 19, or 20 layers of a polymer film described herein.

In various embodiments, the polymer (e.g., the electrochemically polymerized polymer) in each layer of a multilayered polymer film is the same. In certain embodiments, the polymer (e.g., the electrochemically polymerized polymer) in two or more layers of the of the multilayered polymer film is different. In particular embodiments, the polymer (e.g., the electrochemically polymerized polymer) in at least one layer of the multilayered polymer film is a conductive polymer.

### Devices

In another aspect, as described herein, the present disclosure provides a device generally comprising a polymer film, or a composite polymer film, or a multilayered polymer film, or multiple polymer films as disclosed herein.

In most embodiments, the device includes a substrate on which the polymer film is associated, adhered, or bonded. In some embodiments, the substrate comprises a conductive surface. In certain embodiments, the conductive surface is a gold surface, a platinum surface, a carbon surface, a titanium surface, a polypyrrole surface, a poly(thiophene) surface, a poly(3,4-ethylene dioxythiophene) surface, a poly(p-aminobenzene sulfonic acid) surface, a polyaniline surface, a poly(dichlorophenolindophenol) surface, a poly(pyrrole-benzophenone) surface, a poly(p-phenylene vinylene) surface, a poly(p-phenylene) surface, a poly(2-mercaptobenzimidazole) surface, an ITO surface, or a combination thereof. In particular embodiments, the substrate is an electrode.

A device that includes a polymer film, or a composite polymer film, or a multilayered polymer film, or multiple polymer films as disclosed herein can be a biomedical sensor, a drug delivery system or device, a bionic implant, a water monitoring device, a nano-actuator, an organic electronic circuit, an organic LED, a battery electrode, a solar cell, a filtration media, an electrochemical sensor, an optical sensor, and/or an electrochemical sensor.

### EXAMPLES

The invention(s) now being generally described, will be more readily understood by reference to the following examples, which are merely for the purposes of illustration of certain aspects and embodiments of the present invention(s), and are not intended to limit the invention(s).

### Example 1. Preparation and Characterization of Conductive Polypyrrole (PPy) and Composite Polypyrrole/Poly(3,4-Ethylene Dioxythiophene (PPy/PEDOT) Thin Films

### 1.1 Chemicals and Materials

Sulfuric acid, potassium dihydrogen phosphate, potassium phosphate dibasic, sodium dihydrogen phosphate, sodium phosphate dibasic, sodium chloride, potassium chloride, pyrrole, and bovine serum albumin were purchased from Sigma Aldrich (Castle Hill, Australia). All chemicals were of analytical grade and were used as received, without further purification. Milli-Q water (>18 MΩ cm) was used to prepare solutions and for surface cleaning procedures.

All the experiments were performed using recombinant lubricin obtained from Lubris Biopharma (Boston, USA). LUB was received as a 2 mg mL⁻¹ solution in sodium phosphate (10 mM), sodium chloride (150 mM) with an additional 0.1% polysorbate stabilizing agent, with a purity of >99.9%. Before use the LUB solution was dialyzed against a polysorbate free solution of PBS (10 mM phosphate buffer, 2.7 mM potassium chloride, 137 mM sodium chloride) using a Slide-A-Lyzer 10,000 molecular weight cut-off dialysis cassette for 24 h. The dialyzing solution was exchanged for a fresh solution at 2, 4 and 8 hours. After dialysis, the LUB solution was diluted with sodium phosphate (10 mM), potassium chloride (2.7 mM), sodium chloride (137 mM) in Milli-Q water to a concentration of 100 μg mL⁻¹, aliquoted into smaller volumes, and flash-frozen in liquid nitrogen until use.

Electrochemical studies were performed using a potentiostat/galvanostat (CH Instruments, Inc.) with a three-electrode cell system. The reference Ag|AgCl (3 M KCl) and the auxiliary platinum electrodes used in the following studies were supplied by Biologic Science Instruments (Seyssinet-pariset, France). All potentials are reported versus a Ag|AgCl (3 M KCl) reference electrode at room temperature.

### 1.2 Quartz Crystal Microbalance Experiments

Prior to use the Au coated crystal quartz sensors were cleaned in a 3:1:1 (by volume) of Milli-Q water, aqueous ammonia, and hydrogen peroxide for 30 minutes at 70° C. The sensors were then rinsed with Milli-Q water and placed for 5 minutes in an ultrasonic bath with ethanol and for another 5 minutes in Milli-Q water. The crystals were then dried with nitrogen gas and cleaned for 15 minutes under biological UV-ozone (BioForce Nanoscience).

Quartz Crystal Microbalance (QCM) experiments were performed using an electrochemical QCM cell (QSense, Biolin Scientific), connected to the potentiostat/galvanostat (CH Instruments, Inc.) described above, with an Ag|AgCl (3 M KCl) reference electrode and the auxiliary platinum electrodes already included in the QCM cell. Au coated sensors were also purchased from QSense, Biolin Scientific. All QCM experiments described herein were performed using a flow cell attachment with flow driven by a peristaltic pump.

The QCM method describes a semi-quantitative measurement of the mass of protein and other biomolecules adsorbing to surfaces and is also used to measure the efficiency of adhesive coatings. (Weidlich et al., Electrochimica Acta, 2005, 50 (7-8), 1547-1552) The mass density of molecules adsorbing to the surface leads to a shift in the oscillating quartz crystal sensor's fundamental resonance frequencies (i.e., ΔF) that are proportional to the change in mass of the crystal (i.e., Δm). The relationship between ΔF and Δm may be described by the well-known Sauerbray equation (Marx, Biomacromolecules, 2003, 4 (5), 1099-1120), used to calculate the change in mass, Δm, of the quartz crystal sensor from the resonant frequency shift, ΔF:

$$\frac{Δ F}{n} = - \frac{2 {F}_{0}^{2}}{A \sqrt{{t}_{q} {ρ}_{q}}} Δ m = - \frac{Δ m}{C} \qquad ( 1 )$$

Where n is the overtone number (n=7 in this work), F₀ the fundamental frequency of the quartz sensor (F₀=5 MHz), A the surface area of the piezoelectric region of the sensor, t_{q} the sensor thickness and ρ_{q} the sensor density. The frequency n=7 was chosen because of its balanced between mass sensitivity and frequency stability (i.e., low noise). For this study, C=17.7 g cm⁻² Hz⁻¹, which is a material constant valid for a quartz crystal sensor with a fundamental frequency of 5 MHz.

It is important to note that the Sauerbray equation is only quantitively valid for films that are uniformly thick and dense, ridged, and perfectly elastic. Viscoelastic dampening, due to viscous dissipation in the adsorbed layer, results in the Saurbrey equation underestimating the actual mass of non-rigid films in fluid (i.e., layers of adsorbed proteins). Despite this error, it provides a means of making semi-quantitative comparisons of polymerized films masses, LUB adsorption amount and between the nonspecific binding (i.e., fouling) of surfaces. (Marx, 2003; George et al., Biomaterials, 2009, 30 (13), 2449-2456; Reimhult et al., Langmuir, 2008, 24 (16), 8695-8700)

All QCM measurements started with the equilibration of the QCM crystal with buffer, here PBS, at a constant flow rate of 300 mL min⁻¹ until a stable frequency baseline was achieved.

100 μL of LUB protein solution at a concentration of 100 μg mL⁻¹ was flowed into the QCM flow cell at a constant flow of 100 mL min⁻¹. Once all of the LUB solution had flowed into the flow cell, the flow was stopped for an incubation period of 10 minutes. The QCM crystal was then rinsed by flowing PBS buffer into the cell at a constant flow rate of 300 mL min⁻¹ until a stable frequency baseline was achieved. The difference in the frequency baselines measured between the last two steps is due to the LUB adsorption (e.g., the frequency change used to calculate the adsorbed mass density in Equation (1)).

Following LUB incubation on the Au sensor in the flow cell, a monomer solution (0.2 M Py or 0.01 M EDOT in Milli-Q water) was flowed into the cell at a constant flow rate of 100 mL min⁻¹. Once the frequency baseline was achieved, a cycling potential from −0.1 V to +1.1 V was applied using a scan rate of 5 mV s⁻¹ that resulted in the growth of a PPy film on the LUB coated QCM crystal with each additional cycle. Similarly, PEDOT was electropolymerized on the Au sensor electrode from an aqueous solution containing EDOT (0.01 M) by applying cycling potential from −0.6 V to +1.1 V, with a scan rate of 5 mV s⁻¹. Once the electropolymerization finished, with the required cycle numbers, the QCM crystal surface was rinsed by flowing PBS buffer into the flow cell at a constant flow rate of 300 mL min⁻¹.

### 1.3 Thickness and Roughness Characterization by AFM

ITO (Delta Technologies Ltd, USA) was chosen as the substrate for the AFM experiments due to its transparency, making it easier to determine the location of the step since the films (particularly at low CV cycles) are nearly invisible. Before polymerizing PPy on the ITO surface, the electrode was first cleaned using the following procedure: (1) sonicated for 15 min in ethanolamine, (2) sonicated for 15 min in isopropanol, (3) sonicated for 15 min in Milli-Q water, and (4) blown dry using nitrogen gas. In order to achieve a sharp step profile on the AFM images, a silicone-free adhesive plastic film (Ultron Systems, Inc.) was placed on an ITO substrate. LUB was coated on the cleaned and masked ITO electrodes by dropping 50 μL of 100 μg mL⁻¹ solution of recombinant LUB onto the surface. After 30 minutes of incubation, the unbound LUB on the substrate was removed by rinsing the surface with PBS buffer. The LUB-coated electrodes were then used to electrochemically grow PPy from an aqueous solution containing freshly distilled Py (0.2 M), free of ionic impurities at the level of Milli-Q (18.2 MΩ cm (at 25° C.)), by applying cycling potential from −0.1 V to +1.1 V, with a scan rate of 5 mV s⁻¹. The resulting films were carefully rinsed with filtered Milli-Q water, dried with nitrogen gas and stored under vacuum. The tape was then carefully removed after electropolymerization prior AFM imaging.

AFM imaging was conducted using a JPK Nanowizard Sense AFM using a Bruker TESPHAR probe that has a 3 sided, pyramidal high aspect ratio tip (nominal angles equal to 5°) with a nominal tip radius of 10 nm at the end of a rectangular silicon doped antimony cantilever beam with a nominal spring constant of 42 N m⁻¹. The scan of the surface was done with using tapping mode in ambient air. All measurements were done using this high aspect ratio tip to capture the PPy's layer thickness and boundaries as accurately as possible and because the high aspect tip best resolves step-height boundaries and is best able to resolve the nanoporosity of the films. Tapping mode was used to avoid any damage to the polymer layer that could have occurred if using contact mode. The RMS surface roughness of the different samples, which specifies the surface roughness of a material by a statistical characterization of the average roughness of a surface, and the peak-to-valley roughness were measured using the processing software JPK data processing version 6.0.26 from JPK instrument. The final RMS of a sample is the average value of measurements at ten different locations (3 μm line, parallel and randomly chosen).

### 1.4 Morphological Characterization by FIB/SEM

Bare SiO₂ surfaces were first rinsed with absolute ethanol (100%, Chem-supply), dried with nitrogen gas, and cleaned with a biological UV-ozone (BioForce Nanoscience) for 15 minutes. The cleaned SiO₂ surfaces were sputter-coated (Quorum Q150T) with a chrome target and then an Au target, respectively, for 20 seconds at 40 Amps and 120 seconds at 20 Amps. The resulting Au working electrodes (˜50 nm layer) were finally UV-ozone cleaned for another 15 minutes and stored under vacuum when not used.

Before the electrochemical polymerization, Au electrodes were washed with Milli-Q water and electrochemically cleaned in H₂SO₄ (0.05 M) by cycling in the potential range from −0.1 V to +1.5 V until reproducible voltammograms were reached.

The cleaned working Au electrodes were masked with silicone-free adhesive plastic films (Ultron Systems, Inc.) previously hole punched. LUB was coated on the cleaned working Au electrodes by dropping 50 μL of 100 μg mL⁻¹ solution of recombinant LUB on the surface. After 30 minutes of incubation, the unbound LUB on the substrate was removed by rinsing the surface with PBS buffer.

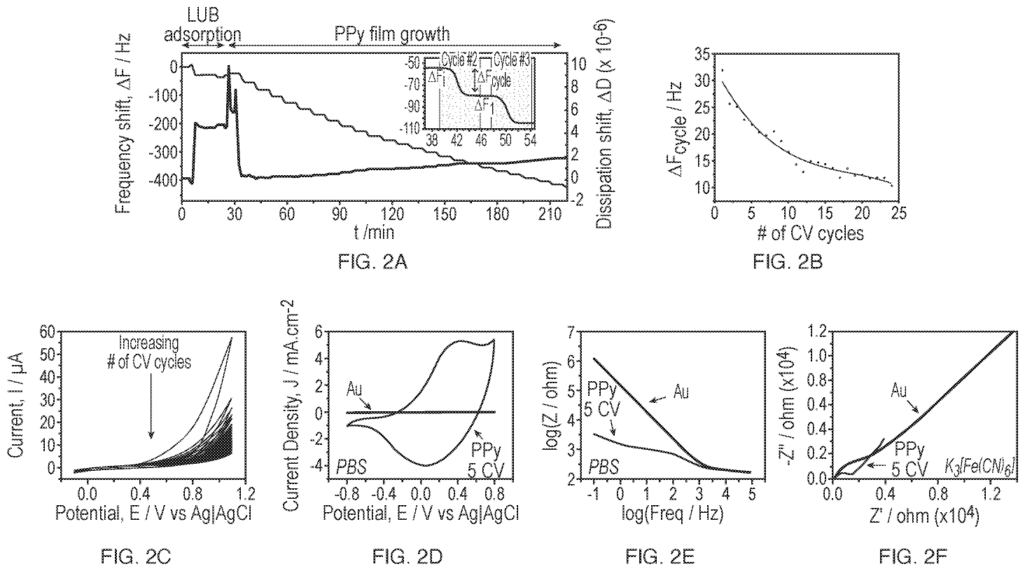

The LUB-coated electrodes were then used to electrochemically grow PPy, with similar parameters, from an aqueous solution containing freshly distilled Py (0.2 M), free of ionic impurities at the level of Milli-Q (18.2 MΩ·cm (at 25° C.)), by applying cycling potential from −0.1V to +1.1 V, with a scan rate of 5 mV s⁻¹ (see FIG. 2C). The resulting films were carefully rinsed with filtered Milli-Q water, dried with nitrogen gas and stored under vacuum.

A Ga Focused Ion Beam Scanning Electron Microscope (FEI Quanta 3D, FEI, Hillsboro, Oregon, USA) was used to generate cross-sections of the polymerized film PPy synthesized for 2 CV cycles. The cross-sectioning process involved 3 steps at 30 keV including (i) a first rough milling at 0.5 nÅ, followed by (ii) cleaning at 0.1 nÅ and (iii) polishing at 0.015 nÅ. The samples were Pd coated prior to milling to reduce damage to the samples surface. Scanning Electron Microscopy (SEM) analysis of the composite films was conducted on a JEOL JSM 7800F SEM. The samples were mounted on aluminum stubs with carbon tape to reduce charging effects. Cross sectional micrographs of the composite films were acquired with a Lower Electron Detector (LED) at a working distance of 10 mm and an accelerating voltage of 5 keV.

### 1.5 Morphological Characterization by TEM

Samples were loaded onto a gold coated 100/400 mesh parallel grid (Emgrid, Australia). The TEM grids were placed on a clean glass slide and connected with conductive metallic tape to the working electrode wire. A 200 μL drop of Py solution (0.2 M) covered the LUB-coated TEM grid with the reference and counter electrodes. The Py polymerization was conducted for 2 CV cycles. TEM imaging was conducted on a JEOL 1010 TEM (JEOL USA, Inc.) at the RMMF at RMIT University. An accelerating voltage of 100 kV was used.

### 1.6 Electrochemical Impedance Spectroscopy (EIS)

Au rod electrodes were cleaned before every experiment using the following polishing procedure. First, Au electrodes were polished using alumina with particle sizes of 0.3 and 0.05 μm for 3 min for each particle size. Then, the Au electrodes were thoroughly rinsed with Milli-Q water and electrochemically cleaned in H₂SO₄ (0.05 M) by cycling in the potential range from −0.1 V to +1.5 V until reproducible voltammograms were reached. After 5 CV cycles of Py electropolymerization, Electrochemical impedance spectroscopy (EIS) spectra were recorded in the frequency range of 105 to 10-1 Hz with initial potential of +0.2 V in PBS solution and of +0.3 V in K3[Fe(CN)6] (3.6 mM) solution prepared in PBS.

### 1.7 X-ray Photoelectron Spectroscopy (XPS)

XPS analysis of conductive polymer films was performed using an AXIS Nova (Kratos Analytical Inc., Manchester, UK) equipped with a monochromated Al Kα X-ray source (λ=1486.6 eV). The hemispherical analyser was operated in fixed analyser transmission mode. The total pressure in the sample analysis chamber during analysis was characteristically below 10⁻⁸ mbar. The photoelectron emission angle was set to 0° which corresponds to a 90° take-off angle measured from the surface. An electron flood gun was used to charge neutralize samples and three spots per sample were analyzed. Casa XPS software version 2.3.15 (Casa Software Ltd., Teignmouth, UK) was used for data processing. The elemental composition on the surface was identified from the survey spectrum. Binding energies of elements were corrected with the reference carbon ¹²C (284.8 eV).

### 1.8 Conductive Polypyrrole (PPy) Thin Films

Quartz crystal microbalance dissipation (QCM-D) combined with an in-situ electrochemical (EC) cell was used to monitor the deposition/polymerization kinetics, mechanical/viscoelastic properties, and electrochemical response of the deposited film via real-time monitoring of the frequency and dissipation shifts and EC currents during cell cycling (FIG. 2).

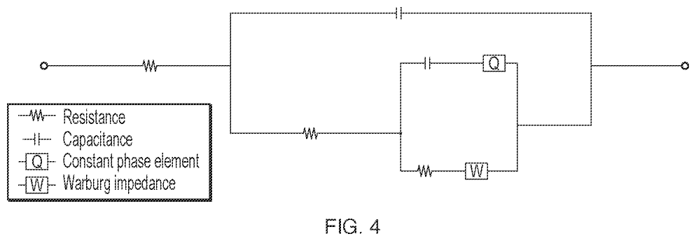

The E-QCM technique, during an electrochemical polymerization of Py on a LUB-coated Au sensor, was used to correlate the CP mass deposition (i.e., the frequency shift-AF) with the electropolymerization time (i.e., the number of CV cycles), revealing the reaction kinetics. FIG. 2A presents the frequency shift, ΔF, and the dissipation shift, ΔD, associated with the electropolymerization of 24 CV cycles of the thin film in the electrochemical cell of the E-QCM. Firstly, the LUB coating was formed by flowing LUB solution in the flow cell which then rapidly self-assembles into a telechelic brush layer (FIG. 4A) leading to a frequency drop ΔF of ˜28 Hz on the 7th harmonic overtone, corresponding to a mass deposition of ˜495 ng cm⁻² (FIG. 2A). After a PBS rinse until a stable frequency baseline was achieved, the monomer Py prepared in distilled water was introduced into the QCM flow cell. The growth of PPy was monitored during a 24 CV cycle of electropolymerization. As seen in FIG. 2A, ΔF being proportional to the mass deposited, decreased during every electrochemical polymerization cycle. This indicated growth of the CP and consequently a reduction in the accessible negative charge density from the LUB's mucin domains after each subsequent cycle. The change in the cycle frequency shift, ΔF_{cycle}=ΔFᵢ−ΔF_{f} (see inset of FIG. 2A), as a function of the CV cycle number is shown in FIG. 2B and demonstrates that the magnitude ΔF_{cycle} becomes progressively smaller with each additional CV cycle. Extrapolating this monotonically decreasing curve suggests that ΔF_{cycle} will eventually drop to zero (i.e., no further growth is possible) after approximately 33-34 CV cycles as seen in FIG. 2B. This gradual slowing and eventual cessation of CP growth can be attributed to the depletion of available negative (dopant) charges on the LUB molecule for supporting continued polymerization.

The PPy growth mechanism was studied by examining the atypical relationship between the frequency and dissipation shifts observed during film formation (FIG. 2A), which for most film growth processes will change in an inversely proportional manner to each other. Further, it is typical that mass deposited by polymerization will lead to an increase in film thickness and result in increased viscoelastic dissipation response (which is most sensitive film thickness) resulting in ΔF and ΔD curves which are ‘mirror’ images of each other. Such an expected inversely proportional response was observed upon the initial self-assembly of the LUB brush onto the Au electrode (FIG. 2A), where the ΔD response is the mirror image of the ΔF response However, as soon as the electropolymerization of PPy was initiated, the correlation between ΔF and ΔD was broken and ΔD decreases sharply, nearly to zero, while ΔF also decreases indicating a large deposition of mass. The sharp decrease in ΔD, was interpreted as a significant increase in the layer rigidity consistent with a thin layer of PPy fully encapsulating the LUB molecules in just the first cycle. Likewise, the gradual successive increase in ΔD with increased cycling while ΔF decreases much more significantly, indicated that the increased mass deposition is not causing the layer thickness to change significantly (as the viscose dampening is most sensitive to changes in layer thickness).

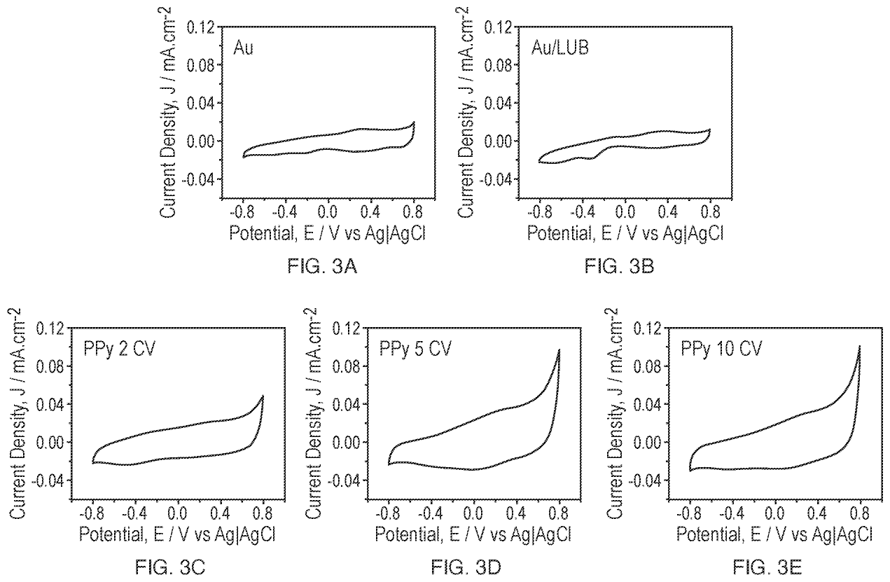

The polymer electrochemical growth profile collected during the QCM measurement is presented in FIG. 2C. Py was oxidized at approximately +0.8 V (vs. Ag|AgCl) (FIG. 2C). The increase in current magnitude in the electrochemical profile between-0.1 V and +1.1 V indicated that a conductive polymer film was deposited on the working Au electrode, which result is consistent with the decreasing ΔF in the QCM measurements. Further, the low mobility of the LUB dopant charges reduced the growth kinetics, leading to the selection of a low scan rate (FIG. 2C). The rate is directly impacted by the low mobility of the dopant charge. Once the network ‘solidifies’ and the LUB molecules appear to be fully ‘coated’ very rapidly by the PPy film, the LUB charge effectively becomes immobile. In this case, the ‘electrons’ have to find the doping charge, which may be located further away from the electrode surface. Therefore, the electropolymerization parameters differ and further reactions will then depend upon the ionic mobility within PPy. The scan rate must be minimized to allow reasonable access to the tethered LUB negative charge and an adequate polymerization of the monomer moieties. CV characterization of the resulting film was conducted in PBS solution and was used to assess the electrochemical activity of the deposited PPy films (FIG. 2D). The electrochemical activity and conductivity of the CP film grown from just 5 CV cycles is shown in FIG. 2D with the shape of the CV confirming the presence of a highly conductive PPy film on the electrode, with a larger capacitive current compared to the bare Au electrode. The electrochemical activity of PPy films electropolymerized at different CV cycles in PBS solution (See FIGS. 3C-3E) indicated a similar profile for all CV cycles and a increasing capacitive current with increasing CV cycles.

To further characterize the electrochemical properties of these thin PPy films, impedance experiments were performed in PBS solution and in K3[Fe(CN)6] prepared in PBS solution for a bare Au electrode and a PPy film electropolymerized for 5 CV cycles (FIGS. 2E and F, respectively). The EIS spectra were recorded in the frequency range of 105 to 10-1 Hz. FIG. 2E presents the bode plot of Au and Au/PPy 5 CV cycles in PBS. The impedance of PPy doped with the surface tethered LUB is greatly lower in comparison to the bare Au electrode. FIG. 2F presents the Nyquist plot of a bare Au electrode and Au/PPy 5 CV cycles in K3[Fe(CN)6] solution. As observed in this result, the Au/PPy 5 CV presented a smaller charge transfer resistance (R_{ct}) compared to a bare Au, which corroborates with the previous result presented FIG. 2E. The Au/PPy 5 CV showed a R_{ct} value of 1.13 kΩ, compared to the Au electrode R_{ct} at 2.13 kΩ.

The representative circuit used to calculate the R_{ct} value is presented in FIG. 4. The modelling of EIS spectra for bare Au or PPy electrodes surface was done using an electrical equivalent circuit, which consists of a solution resistance Rₛ connected in series with the film capacitance and resistance, C_{f} and R_{f} (elements in parallel to each other) and in series with the double layer capacitance C_{dl}, charge transfer resistance, R_{ct}, a constant phase element, Q and Warbug impedance, Z_{w}, respectively.

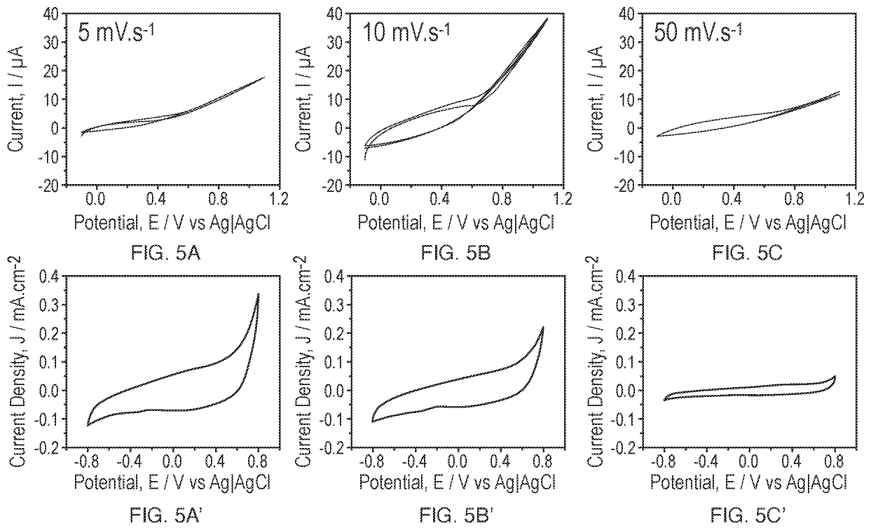

FIGS. 5A-5C and 5A′-5C′ present LUB-coated surfaces polymerized at different scan rates and their electrochemical characterization via CVs in PBS, which confirmed that more time was required to grow a conductive PPy film compared to a ‘free dopant’ process. The capacitive charge is indeed more significant for a slower scan rate of 5 mV s⁻¹ (FIG. 5A′ compared to FIGS. 5B′ and 5C′).

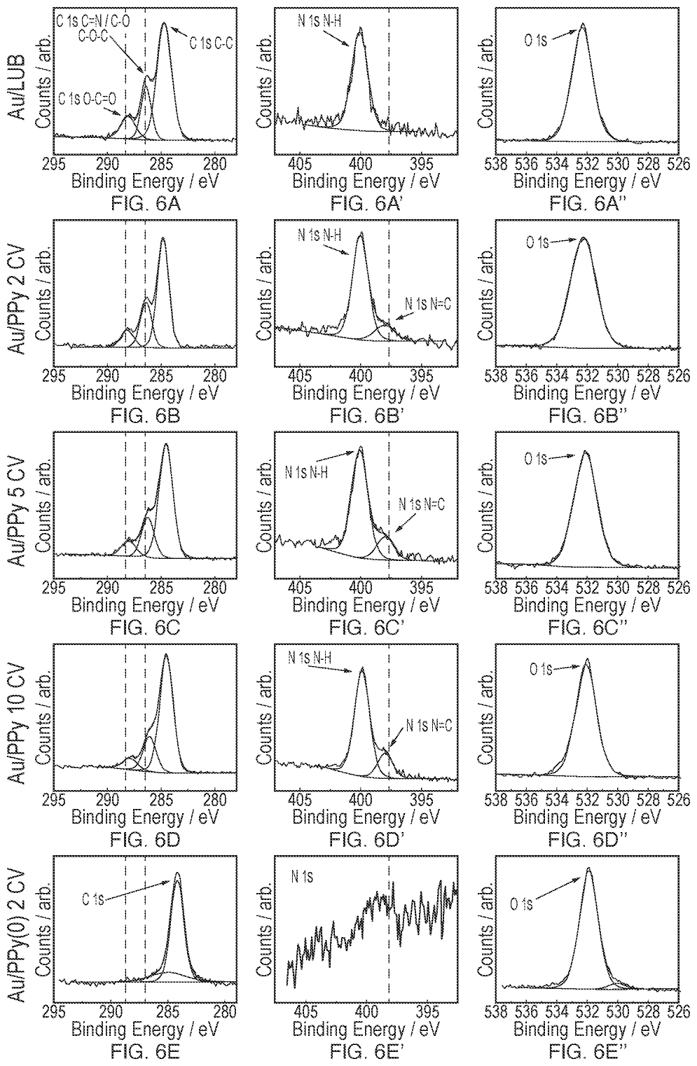

FIGS. 6(a)-(a″), (b)-(b″), (c)-(c″), (d)-(d″) and (e)-(e″) show the XPS elemental composition analysis of PPy thin films confirms PPy polymerization on Au electrode surface with tethered LUB mucin domain acting as counter-ion during the electropolymerization. More specifically, all spectra confirm the elemental composition of the LUB-coated Au electrode as control (FIGS. 6(a)-(a″)) and PPy electropolymerized for 2, 5 and 10 CV (respectively, FIGS. 6(b)-(b″), 6(c)-(c″) and 6(d)-(d″)). The Au/PPy(0) electrode surface presented in FIGS. 6(e)-(e″) is a LUB-coated Au electrode placed in DI water and electropolymerized with the same potential window in a three-electrode cell. This has been done to ensure that LUB is a dopant in the process and that no PPy is formed without a self-assembled LUB layer present at the surface: no element N on the surface (FIG. 6(e′)). The analysis of the C 1s HR spectra for the series shows that the ratio of PPy to LUB increases with the polymerization cycle, as seen in FIGS. 6(b)-(d″). The intensity of the LUB peaks remains the same, while additional carbon is added. N1s peak (FIGS. 6(b′)-(d′)) has a shoulder coming in, from an N═C bond, indicating the same trend: more PPy is present on the surface, while LUB is less present, hence covered by the PPy film. LUB presence is confirmed with the peak O—C—O (FIGS. 6(a′)-(d′)), specific to the carboxyl group found primarily in the sialic acid residues of the mucin domain glycan. The O1s peak only confirms the presence of oxygen in the systems, probably coming from organic impurities during the transfer of the samples (intensity on fact low, as the units, are arbitrary).

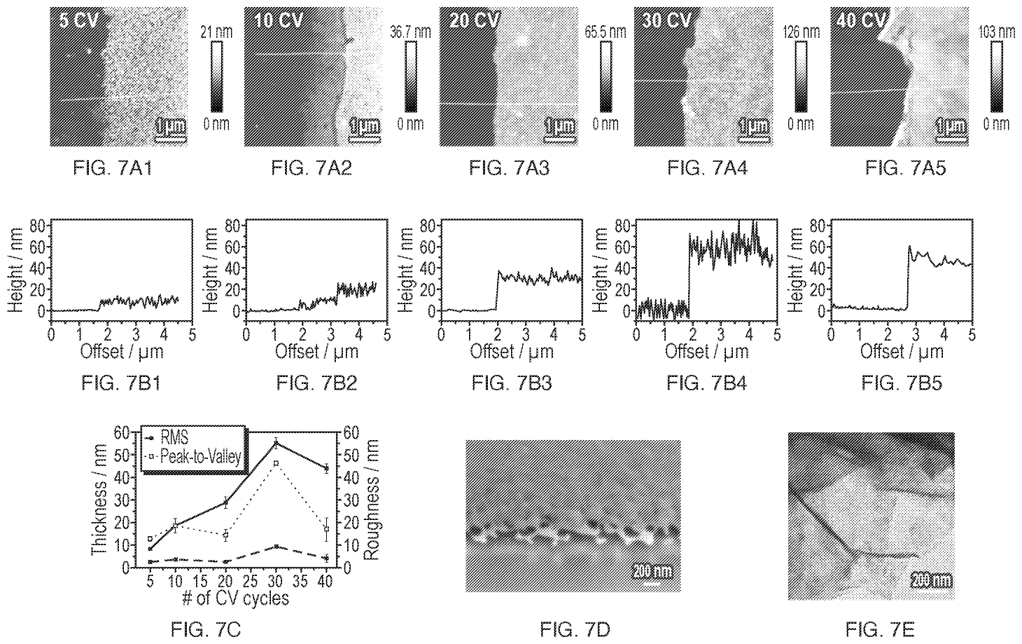

In order to gain more insight into the influence of the dopant tethering on the film formation processes, a detailed characterization of the thin film morphology was carried out (FIG. 7). First, AFM imaging was used to assess the nanoscale morphology and overall thickness of the films at different CV cycles (FIGS. 7A₁-A₅ and 7B₁-B₅). PPy films grown using 5 CV cycles were the thinnest we could assess from AFM because the films grown using lower CV cycles were optically invisible and so the AFM tip could not be positioned at the PPy film boundary. Initially, after just 5 CV cycles, the film was extremely thin at just 10 nm thickness with a large nanoporosity (FIGS. 7A₁ and 7B₁). The nanoporosity is a product of the polymer initially enveloping the LUB molecules and ‘fusing together’ adjacent molecules into a contiguous network. As the number of CV cycles increases (FIGS. 7A₂-7A₅ and FIGS. 7B₂-7B₅), the film grew slightly thicker from ˜10 nm (FIG. 7B₁) to ˜30 nm (FIG. 7B₅) while the nanoporosity became increasingly smaller and more ‘solid’. This trend of polymerization increasing the film solidity rather than increasing its thickness is consistent with the ΔF and ΔD trends observed in FIG. 2A that indicated the deposited PPy mass increases film rigidity (i.e., lower film porosity) to a greater extent than it increases the film thickness. Eventually, as the plot of the film thickness vs. CV cycles in FIG. 7C shows, the film thickness eventually plateau around the same CV cycles predicted in the E-QCM analysis (FIG. 2A), namely ˜33-34 cycles. At the end-stage after 40 cycles, the film is mostly solid with a thickness ˜½ that of the initial 100 nm LUB brush layer height. Multiple film thickness measurements indicated very low thickness variation, as is also indicated by the tight error bars in the thickness vs. CV cycles data presented in FIG. 7C.

Looking at the morphology of the films at different CV cycles number, it is clear that the porosity decreased with increased CV cycles (FIGS. 7A₁-7A₅) but a corresponding increase in the measured roughness of the PPy film surface measured either as a RMS surface roughness nor peak-to-valley roughness was not observed (see FIG. 7C). Compared to the RMS surface roughness of bare ITO, measured at ˜1 nm, the RMS surface roughness of all films (FIG. 7C) is about ˜2.65 nm or just slightly larger than the roughness of the underlying substrate. This tight correlation between the substrate roughness and the film roughness is likewise indicative of a uniformly thick film with little variation across the film area which would contribute to higher RMS and also peak-to-valley roughness. The capacity of the PPy film to conform to the nanostructure of the underlying substrate was observed for the 30 CV cycle film (FIGS. 7A₄ and 7B₄), where the PPy film was unintentionally polymerized on top of an ITO electrode having a much greater RMS surface roughness (i.e., 5.42 nm) resulting in a similar PPy film (RMS surface roughness of 9.29 nm). The peak-to-valley roughness Rt for the PPy thin films for each CV cycles (except the unusually rough ITO used for the 30 CV film) is about ˜ 10 nm (FIG. 7C). Again, the peak-to-valley roughness of the 30 CV cycles PPy film grown on the anomalously rough ITO substrate shows a much higher roughness (i.e., 46.42 nm) than the other films, which again is similar in scale to that of the underlying ITO. The similarity of the PPy film's nanomorphology with that of the ITO substrate supports the film thickness uniformity even at these nanoscale dimensions.

SEM coupled with a focused ion beam was used to assess any internal structure of the PPy thin films to confirm the nanoporous nature of the films suggested in the AFM imaging study. A Ga Focused Ion Beam was used to mill a cross-section of PPy film polymerized using 2 CV growth cycles (FIG. 7D). The image of PPy film (tilted in the SEM chamber for ease of imaging) clearly showed a uniformly coated substrate with a nanoporous morphology. The PPy film's thickness was difficult to assess due to the tilting of the samples during the SEM imaging; however, based on the AFM analysis described above, it is estimated to be ≤10 nm. The nanoporous PPy network observed in the SEM (FIG. 7D) and AFM (FIG. 7A₁) closely resembles the structure of a dehydrated LUB brush deposited on a molecularly smooth HOPG substrate and imaged using high resolution tapping mode AFM. (Jay et al., Arthritis & Rheumatism, 2007, 56 (11), 3662-3669) The similarities between the mesh-like nanostructure of the dehydrated LUB and that of the PPy film after the first 2 CV growth cycles strongly supports that the film nanoporous structure is templated by the innate nanostructure of the LUB brush network and is not an artifact of the polymerization reaction. For further analysis, TEM was used to visualize the uniformity of the electropolymerized film for 2 CV cycles (FIG. 7E). This image revealed extremely thin films which were uniformly coated and with a free-standing continuous network. The ‘peeled off’ appearance of the film is due to the TEM grid's handling and the long air and vacuum exposure during transport and imaging. The PPy films grown using just 2 CV cycles are approaching the thickness dimensions of a 2D nanomaterial demonstrating a very high transparency to light. For all practical purposes, they are effectively transparent. A conformal coverage of the TEM grid was achieved, by applying cycling voltammetry on a LUB-coated TEM gird immerged in Py solution.

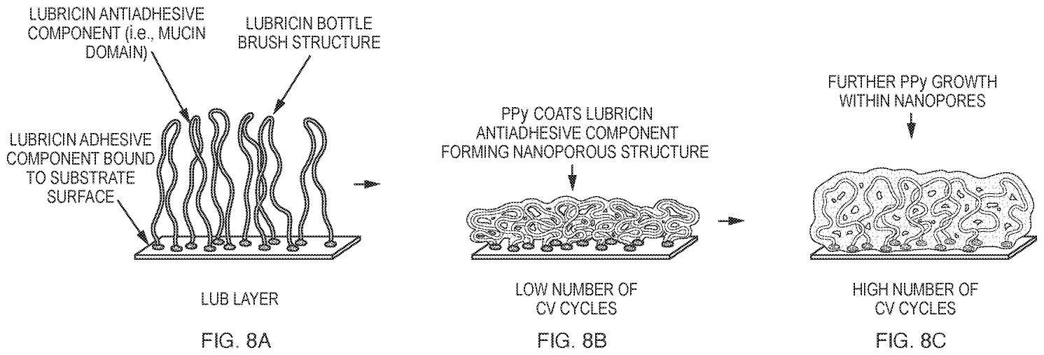

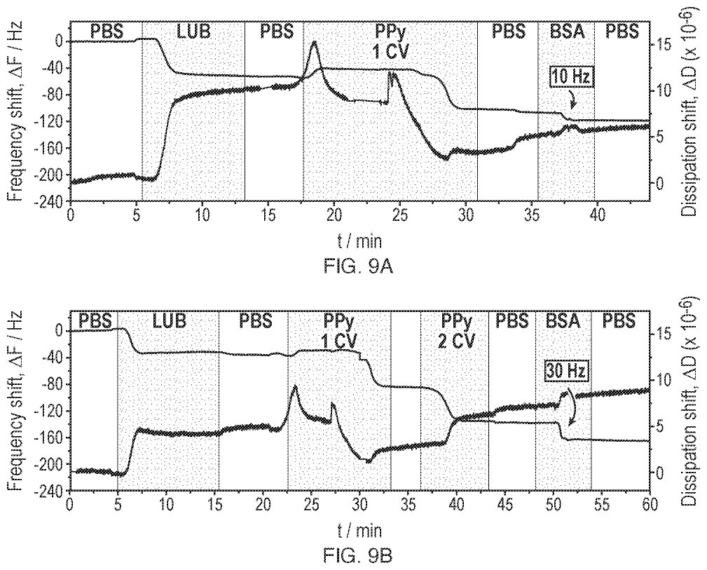

Based on the results of the QCM, AFM, SEM, and TEM studies described above, the mechanism by which these nanometers-thin, ultra-uniform PPy films are formed can be elucidated. This mechanism is illustrated in FIGS. 8A-8C. The frequency trend of the QCM experiment (FIGS. 2A and 2B) shows that reaction kinetics and film morphology is partly controlled by the number of negative charges presented on the LUB molecule. This results in the following growth formation (see FIGS. 8A-8C), where FIG. 8A depicts self-assembly of LUB into a brush-like monolayer on a conductive substrate as the start of the process. FIG. 8B depicts after the first CV cycle, the PPy film immediately encapsulates the LUB molecules leading to a porous film with a network structure that reflects that of a dehydrated LUB brush-like layer. Evidence that the LUB molecules become fully enveloped by deposited PPy after the second CV growth cycle is seen in QCM experiments investigating the biofouling of these films by bovine serum albumin protein (See FIGS. 9A and 9B). LUB is an excellent bristle which inhibits the non-specific adsorption of protein. By the second CV cycle, the adsorption of BSA to PPy film greatly increases and becomes similar to that observed with traditionally polymerized PPy films. (Han et al., ACS Applied Nano Materials, 2020, 3 (11), 11527-11542). FIG. 8C depicts with continued electropolymerization, additional PPy growth occurs primarily within the pores of the network. The pores are hence filled in, leading to a full conductive polymer film when the LUB is totally covered (i.e., when no negative charges are available and the electropolymerization completed), as seen in FIGS. 8A-8C. The nanometers-thin film has a controlled growth, which is templated by the LUB brush's well-defined molecular structure resulting in a film that is similarly ultra-smooth, uniformly thick, conductive, and conforms to the nano-, micro-, and macro-scale structures of the supporting electrode. The templating/morphology of the dopant controls the film structure thereby disconnecting the ‘reaction kinetics’ (i.e., diffusion, charge density and distribution, etc.) which is normally impossible to control effectively to obtain thin uniform coatings.

### 1.9 Conductive PPy/PEDOT Thin Films

The unique film formation process described above, involving first the envelopment of LUB by a conductive polymer into a nanoporous network followed by the gradual filling in of the network porosity, creates a new opportunity for synthesizing a new type of conductive composite polymer film composed of two interpenetrating, continuous polymer networks. This approach differs fundamentally from multilayer assembly or phase separated polymer blends most often used to make composite polymer films.

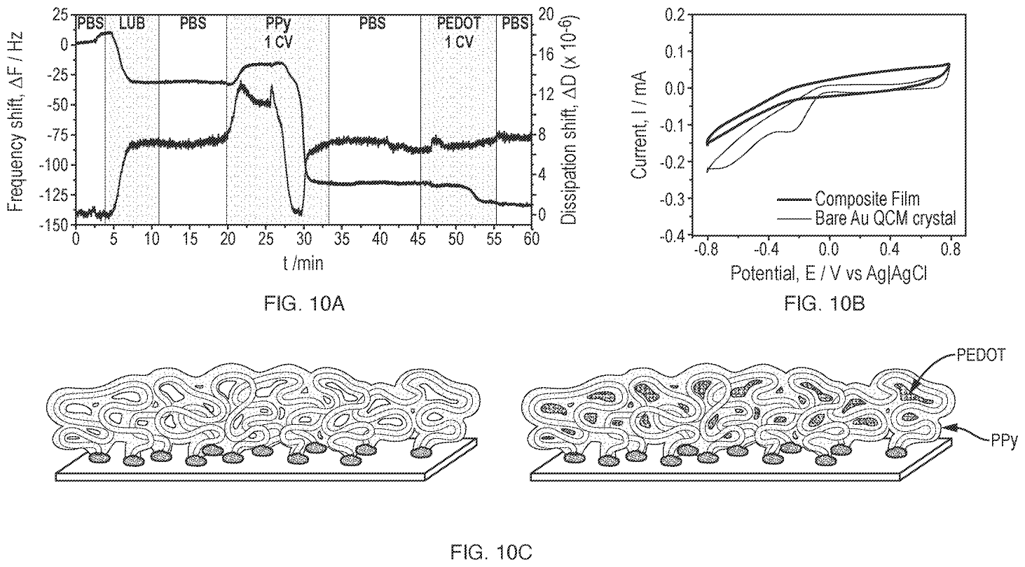

Fabrication of duel, interpenetrating continuous networks of two or more polymers is achieved by stopping the growth of the first polymer at the nanoporous stage, and then growing a second polymer within the pores of the first. PPy/PEDOT composite films were synthesized using this novel approach (see FIGS. 10A, 10B, 10C(1) and 10C(2)).

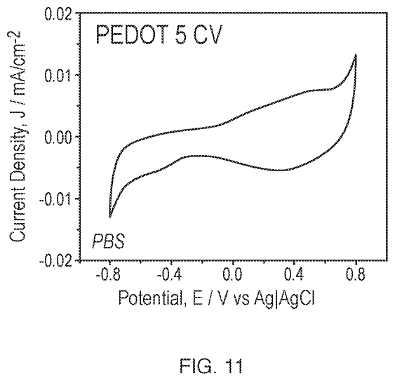

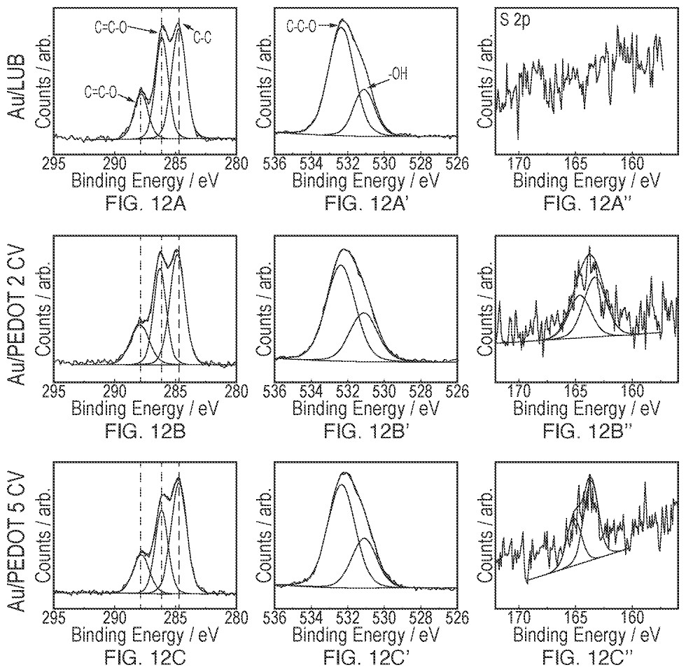

First, to show that the tethered dopant approach can be applied to the polymerization of PEDOT films, EDOT polymerization was carried out using the same procedure described herein for preparing the PPy films. The ability to synthesis PEDOT using a tethered LUB layer as described above for PPy was confirmed by CV electrochemical characterization (FIG. 11). The CV of the PEDOT shows the characteristic features, namely expected oxidation (i.e., ˜+0.3 V) and reduction (i.e., −0.6 V) peaks. PEDOT growth was also confirmed by XPS elemental composition analysis, showing a sulfur peak associated with PEDOT (FIG. 12). That is, all survey spectra show that all samples have a similar composition of carbon elements (FIGS. 12(a)-(c)), with the peak O—C—O (FIGS. 12(a′)-(c′)), specific to the carboxyl group found in LUB's mucin domain. A specific sulphur peak appeared with the PEDOT electropolymerization using LUB as a dopant, increasing with the number of cycles of the electrodeposition (FIGS. 12(b″) and 12(c″)).

The composite CP film was polymerized by first performing a Py polymerization followed by an EDOT polymerization which was all monitored by E-QCM. FIG. 10A shows the frequency (ΔF) and dissipation (ΔD) during the growth of a composite film made of PPy and PEDOT. PPy electropolymerization for 1 CV cycle was followed by an EDOT electropolymerization for 1 CV cycle, using the same LUB layer to dope both polymers. CV characterization of the composite PEDOT/PPy was conducted in PBS solution and was used to assess the electrochemical activity (FIG. 10B). These CVs look compressed due to the large reduced oxygen current generated below −0.4 V57 in the QCM cell. The QCM data indicates that the ΔF for PPy is much greater than for PEDOT (FIG. 10A). The QCM clearly shows mass increase that can be attributed to CP growth. If no reduced oxygen generated below −0.4 V or a CV that do not go below −0.4 V, the CV feature could be said to be dominated by the PPy due to its greater mass deposition and therefore great percentage of the final composite. The composite CV does not show any feature of PPy and PEDOT though (i.e., no specific redox peaks), as PEDOT is grown within PPy and the electrodes surfaces activity will in consequence be a mix of PEDOT and PPy electrochemical features. Since incomplete polymerization results in a porous film (FIG. 10C(1)) after PPy polymerization, composite films can be grown by the addition of a second EDOT monomer which polymerizes within the pores of the previously deposited polymer (FIG. 10C(2)).

The above studies show a process for the rapid, simple, and controllable formation of an nanometers-thin conductive polymer film. This process is enabled by the self-assembled and patterned dopant (e.g., lubricin), leading to a highly robust and repeatable synthesis process. The electrochemical polymerization (i.e., by CV) mechanism of the Au/PPy was monitored and characterized by quartz crystal microbalance experiments indicating that negative charges of LUB enable the polymerization to occur, with a decreased film deposition after each CV cycles, showing that LUB negative charges were less and less available. Electrochemical characterization of the PPy films indicate that they are highly conductive with properties comparable to traditionally grown electropolymerized PPy materials. FIGS. 2E and 2F demonstrate the higher conductivity of the PPy films preparing in this Example. The film resistance was found from the Nyquist plot (shown in FIG. 2F) which is the point where the ‘semi-circle’ region of the imaginary component of the impedance (Z″) observed at low Z′ (the ‘real’ component of the Impedance response, which has the units Ohms). Where this semi-circular region (or an extrapolation of this curve) touches the x-axis is the ‘series resistance’ (this is the combined resistance of the surface film and the electrolyte). The semi-circle of the polymer is smaller than the Au film (in the same electrolyte) indicating that the resistance is smaller. Since conductivity is the inverse of resistance, this means that the conductivity of the polymer film is higher than the Au. Surface characterization of the PPy film indicates the nanoporous structure of the PPy film was easily controllable with the number of cycles during the electrochemical polymerization. The electrochemical growth of CP films, enabled by tethered dopant approach, leads to nanometers-thin films with ultra-uniform film thickness with controlled porosity. The uniformity of these CP films results in conformal coverage of the underlying electrode producing films which nearly perfectly mirror the macro-, micro- and nano-structural features of the electrode they are deposited on. Since the polymerization of the film is programed by the structure of the tethered LUB dopant layer and continues until all the available charge in the LUB is consumed, in principle, the polymerization end point is the same and can be expected to result in films having identical thicknesses and conformal, uniform coverage irrespective of the particular kinetics of the polymerization reaction. Likewise, the unique film formation mechanism which begins first as a nanoporous network may facilitate electrodes with larger surface areas for sensor and bionic applications and also enable the fabrication of novel composite polymer films composed of two interpenetrating polymer phases. PPy films fabricated using 5 CV cycles or less are continuous and highly transparent due to their extreme thinness which approaches the dimensions of 2D-nanomaterials.

### INCORPORATION BY REFERENCE

The entire disclosure of each of the patent documents and scientific articles referred to herein is incorporated by reference for all purposes.

### EQUIVALENTS

The disclosure may be embodied in other specific forms without departing from the spirit or essential characteristics thereof. The foregoing embodiments are therefore to be considered in all respects illustrative rather than limiting the disclosure described herein. Scope of the disclosure is thus indicated by the appended claims rather than by the foregoing description, and all changes that come within the meaning and range of equivalency of the claims are intended to be embraced therein.

What is claimed is:

1. A polymer film comprising an electrochemically polymerized polymer, wherein the polymer film has a thickness of less than or equal to about 100 nm and a root mean square (RMS) surface roughness of less than or equal to about 5 nm.

2. A polymer film comprising an electrochemically polymerized polymer; and a polyelectrolyte, wherein the polymer film has a thickness of less than or equal to about 100 nm and/or a root mean square (RMS) surface roughness of less than or equal to about 5 nm.

3. The polymer film of claim 1 or 2, wherein the polymer film has an optical transmission in the visible light wavelengths from about 60% to about 97%.

4. The polymer film of any one of claims 1-3, wherein the polymer film has a conductivity from about 0.1 S/cm to about 100 S/cm.

5. The polymer film of any one of claims 1-3, wherein the polymer film is a non-conductive polymer film.

6. The polymer film of any one of claims 1-4, wherein the polymer film is a conductive polymer film.

7. The polymer film of any one of claims 2-6, wherein the polyelectrolyte comprises a bristle component and an adhesive component.

8. The polymer film of claim 7, wherein the bristle component is the mucin domain of a lubricin.

9. The polymer film of claim 7 or 8, wherein the adhesive component is an adhesive globular end domain of a lubricin.

10. The polymer film of any one of claims 7-9, wherein the adhesive component comprises a first adhesive component and a second adhesive component.

11. The polymer film of any one of claims 2-10, wherein the polyelectrolyte comprises a lubricin.

12. The polymer film of any one of claims 1-11, wherein the electrochemically polymerized polymer is a first electrochemically polymerized polymer, and the polymer film further comprises a second electrochemically polymerized polymer.

13. The polymer film of claim 12, wherein the second electrochemically polymerized polymer is located within the pores of the first electrochemically polymerized polymer.

14. The polymer film of any one of claims 1-13, further comprising a cationic compound, an anionic compound, a neutral compound, or a combination thereof.

15. The polymer film of claim 14, wherein the cationic compound, the anionic compound, and/or the neutral compound is a therapeutic agent.

16. The polymer film of any one of claims 7-15, wherein the adhesive component is associated with a substrate.

17. A composite polymer film comprising a first electrochemically polymerized polymer and a second electrochemically polymerized polymer, wherein the first electrochemically polymerized polymer and the second electrochemically polymerized polymer are interpenetrating and continuous, and the polymer film has a thickness of less than or equal to about 100 nm and/or a root mean square (RMS) surface roughness of less than or equal to about 5 nm.

18. The composite polymer film of claim 17, further comprising a polyelectrolyte.

19. A device comprising one or more polymer films of any one of claims 1-16, or composite polymer films of claim 17 or 18.

20. The device of claim 19, further comprising a substrate, wherein the substrate comprises a conductive surface, and the one or more polymer films or composite polymer films is associated with the substrate.

21. A method of preparing a polymer film comprising:
(a) contacting a solution comprising a plurality of one or more electrochemically polymerizable monomers with a monolayer of a polyelectrolyte coated on a substrate; and
(b) applying one or more cycling voltammetry (CV) cycles to the solution to form the polymer film.

22. The method of claim 21, wherein the substrate comprises a conductive surface.

23. The method of claim 21 or 22, wherein the thickness of the monolayer of the polyelectrolyte on the substrate is less than or equal to about 200 nm.

24. The method of any one of claims 21-23, wherein the density of the polyelectrolyte on the substrate is from about 50 ng/cm² to about 5000 ng/cm².

25. The method of any one of claims 21-24, wherein the polyelectrolyte comprises a bristle component and an adhesive component.

26. The method of claim 25, wherein the bristle component comprises one or more ionic functional groups.

27. The method of claim 25 or 26, wherein the bristle component comprises greater than 50 ionic charges per polyelectrolyte molecule.

28. The method of any one of claims 25-27, wherein the polyelectrolyte consists of one bristle component and one adhesive component.

29. The method of claim 28, wherein the one adhesive component is located near or at a terminal end of the polyelectrolyte.

30. The method of any one of claims 25-27, wherein the polyelectrolyte consists of one bristle component and two adhesive components.

31. The method of claim 30, wherein one of the two adhesive components is located near or at one terminal end of the polyelectrolyte and the other of the two adhesive components is located near or at the other terminal end of the polyelectrolyte.

32. The method of any one of claims 25-31, wherein the bristle component comprises a single strand or a single polymeric chain.

33. The method of any one of claims 25-31, wherein the bristle component comprises a single strand or a single polymeric chain, wherein the single strand or the single polymeric chain further comprises one or more branched strands or branched chains emanating from the single strand or the single polymeric chain.

34. The method of any one of claims 25-33, wherein in step (a), the bristle component is oriented substantially in a direction away from the substrate.

35. The method of any one of claims 25-34, wherein the adhesive component interacts with the substrate via a covalent bond, an ionic bond, a hydrogen bond, a van der Waals interaction, a metallic bond, or a combination thereof.

36. The method of any one of claims 21-35, wherein in step (b), 1 to 35 CV cycles is applied to the solution.

37. The method of any one of claims 21-36, wherein the method further comprises removing the polymer film from the substrate.

38. The method of any one of claims 21-37, wherein the monolayer of the polyelectrolyte is coated on the substrate in a pattern and the resulting polymer film is substantially in the form of the pattern.

39. The method of any one of claims 21-38, wherein the polymer film is a conductive polymer film.

40. The method of any one of claims 21-39, further comprising after step (b), contacting a solution comprising a plurality of one or more different electrochemically polymerizable monomers with the polyelectrolyte and polymer film; and applying one or more cycling voltammetry (CV) cycles to the solution to form a composite polymer film.

41. The method of any one of claims 21-40, wherein the resulting polymer film has a thickness of less than or equal to about 100 nm and/or a root mean square (RMS) surface roughness of less than or equal to about 5 nm.

42. A method of preparing a multilayered polymer film comprising two or more layers of a polymer film of any one of claims 1-16 or a composite polymer film of claim 17 or 18, the method comprising:
(a) preparing a first polymer film using the method of any one of claims 21-41; and
(b) disposing a second polymer film onto the first polymer film to form a multilayered polymer film.

43. The method of claim 42, wherein disposing the second polymer film onto the first polymer film comprises:
(i) creating a monolayer of the polyelectrolyte coated on a surface of the first polymer film;
(ii) contacting a solution comprising a plurality of one or more electrochemically polymerizable monomers with the monolayer of the polyelectrolyte; and
(iii) applying one or more cycling voltammetry (CV) cycles to the solution to form the second polymer film of the multilayered polymer film.

44. The method of claim 42 or 43, wherein in step (iii), 1 to 35 CV cycles is applied to the solution.

45. The method of any one of claims 42-44, wherein the method further comprises disposing one or more additional layers of a polymer film onto the multilayered polymer film.

46. The method of any one of claims 42-45, wherein the polymer of the first polymer film is different than the polymer of the second polymer film.
